(19) United States
(12) Patent Application Publication
(10) Pub. No.: US 2011/0169995 A1
(43) Pub. Date: Jul. 14, 2011

(54) IMAGE PICKUP LENS, IMAGE PICKUP MODULE, AND PORTABLE INFORMATION DEVICE

(76) Inventors: Norimichi SHIGEMITSU, Osaka-shi (JP); Hiroyuki Hanato, Osaka-shi (JP)

(21) Appl. No.: 13/005,877

(22) Filed: Jan. 13, 2011

(30) Foreign Application Priority Data
Jan. 14, 2010 (JP) 2010-006163

(51) Int. Cl. H04N 5/225; G02B 9/10; B23P 11/00

(52) U.S. Cl. 348/340; 359/795; 29/428; 348/E05.024

(57) ABSTRACT

In order to provide an image pickup lens, an image pickup module, and a portable information device that make it possible to reduce the risk of deterioration in optical characteristic by achieving satisfactory resolving performance in an area surrounding a shot image, an image pickup lens includes a first lens having an Abbe number of greater than 45 and second lens having an Abbe number of greater than 45 and satisfies mathematical expression (1):

−3.6<f2/f1<−2.5 (1)

where f1 is the focal length of the first lens and f2 is the focal length of the second lens.

This Nonprovisional application claims priority under 35 U.S.C. §119(a) on Patent Application No. 2010-006163 filed in Japan on Jan. 14, 2010, the entire contents of which are hereby incorporated by reference.

### TECHNICAL FIELD

The present invention relates to image pickup lenses image pickup modules, and portable information devices that are to be mounted into digital cameras, etc. of portable terminals. In particular, the present invention relates to: an image pickup module in which a solid-state image sensing device is used; an image pickup lens well-suited for application to such an image pickup module; and a portable information device including such an image pickup module.

### BACKGROUND ART

Various types of compact digital cameras, compact digital video units, etc. containing solid-state image sensing devices such as CCDs (charge-coupled devices) and CMOSs (complementary metal-oxide semiconductors) have been developed to serve as image pickup modules. In particular, since various types of portable terminals such as portable information terminals and portable phones have been in widespread use in recent years, image pickup modules that are mounted into such portable terminals are required to be small in size and low in height, let alone to be high in resolving power.

As a technique that can satisfy these small-size and low-height requirements, a technique for reducing the size of and lowering the height of an image pickup lens that is provided in such an image pickup module has drawn attention. As examples of such a technique, Patent Literatures 1 to 3 discloses image pickup lenses configured as described below.

Each of the image pickup lenses disclosed in Patent Literature 1 to 3 includes an aperture stop, a first lens, and a second lens with the aperture stop, the first lens, and the second lens sequentially arranged along a direction from an object (subject) to an image surface (imaging surface). The first lens is a meniscus lens having a positive refracting power and having a convex surface facing the object. The second lens is a lens both surfaces of which are concave surfaces facing the object and the image surface respectively.

For the purpose of compactness and satisfactory aberration correction without an increase in the number of lenses, the image pickup lens (shooting lens) disclosed in Patent Literature 1 is further configured to satisfy mathematical expressions (X) and (Y) as follows:

0.6<f1/f<1.0 (X)

1.8<(n1−1)f/r1<2.5 (Y)

where f is the focal length of the lens system, f1 is the focal length of the first lens, n1 is the refractive index of the first lens, and r1 is the curvature radius of that surface of the first lens which faces the object.

However, the image pickup lens disclosed in Patent Literature 1 is insufficient in size reduction and insufficient to achieve satisfactory resolving performance in an area surrounding a shot image.

In order to achieve a small-sized image pickup lens, constituted by two lenses, which has satisfactory optical characteristics, the image pickup lens disclosed in Patent Literature 2 is further configured, using a second lens having a negative refracting power, to satisfy mathematical expressions (A) to (D) as follows:

0.8<ν1/ν2<1.2 (A)

50<ν1 (B)

1.9<d1/d2<2.8 (C)

−2.5<f2/f1<−1.5 (D)

where ν1 is the Abbe number of the first lens, ν2 is the Abbe number of the second lens, d1 is the center thickness of the first lens, d2 is the distance between that surface of the first lens which faces the image surface and that surface of the second lens which faces the object, f1 is the focal length of the first lens, and f2 is the focal length of the second lens.

Further, in order to achieve a small-sized image pickup lens, constituted by two lenses, which has satisfactory optical characteristics, the image pickup lens disclosed in Patent Literature 3 is further configured, using a second lens having a negative refracting power, to satisfy mathematical expressions (E) and (F) as follows:

−2.5<f2/f1<−0.8 (E)

0.8<νd1/νd2<1.2 (F)

where f1 is the focal length of the first lens, f2 is the focal length of the second lens, νd1 is the Abbe number of the first lens on d-rays (at a wavelength of 587.6 nm), and νd2 is the Abbe number of the second lens on d-rays.

### CITATION LIST

### Patent Literature 1

Japanese Patent Application Publication, Tokukai, No. 2006-178026 A (Publication Date: Jul. 6, 2006)

### Patent Literature 2

Japanese Patent Application Publication, Tokukai, No. 2008-309999 A (Publication Date: Dec. 25, 2008)

### Patent Literature 3

Japanese Patent Application Publication, Tokukai, No. 2009-251516 A (Publication Date: Oct. 29, 2009)

### Patent Literature 4

Japanese Patent Application Publication, Tokukai, No. 2009-018578 A (Publication Date: Jan. 29, 2009)

### Patent Literature 5

Japanese Patent Application Publication, Tokukai, No. 2009-023353 A (Publication Date: Feb. 5, 2009)

### SUMMARY OF INVENTION

### Technical Problem

However, the image pickup lens disclosed in Patent Literature 2 has such a problem as follows: The image pickup lens undesirably becomes narrower in angle of view because satisfaction of mathematical expression (D) causes the focal length of the lens system as a whole to be longer; therefore, the image pickup lens remains insufficient to achieve satisfactory resolving performance in an area surrounding a shot image. The term “angle of view” here means an angle within which an image pickup lens can form an image.

By the same token, the image pickup lens disclosed in Patent Literature 3 has such a problem as follows: The image pickup lens undesirably becomes narrower in angle of view because satisfaction of mathematical expression (E) causes the focal length of the lens system as a whole to be longer; therefore, the image pickup lens remains insufficient to achieve satisfactory resolving performance in an area surrounding a shot image.

The present invention is an invention that has been made in view of the foregoing problems, and it is an object of the present invention to provide an image pickup lens, an image pickup module, and a portable information device that makes it possible to reduce the risk of deterioration in optical characteristic by achieving satisfactory resolving performance in an area surrounding a shot image.

### Solution to Problem

In order to solve the foregoing problems, the image pickup lens of the present invention includes: an aperture stop; a first lens; and a second lens, the aperture stop, the first lens, and the second lens being sequentially arranged along a direction from an object to an image surface, the first lens being a meniscus lens having a positive refracting power and having a convex surface facing the object, the second lens being a lens having a negative refracting power, having a concave surface facing the object, and having a surface, facing the image surface, whose central portion has a concave shape, the first lens having an Abbe number of greater than 45, the second lens having an Abbe number of greater than 45, the image pickup lens satisfying mathematical expression (1):

−3.6<f2/f1<−2.5 (1)

where f1 is the focal length of the first lens and f2 is the focal length of the second lens.

The foregoing configuration makes the image pickup lens of the present invention able to satisfactorily correct various aberrations that occur on and outside of the optical axis of light that passes through the first lens and the second lens, thus allowing the image pickup lens of the present invention to be small in size and satisfactory in optical characteristic.

That is, the image pickup lens of the present invention, whose first lens and second lens have Abbe numbers of greater than 45, can suppress chromatic aberrations (lens aberrations causing shifts in position and size of an image extending from one color to another) and therefore achieve satisfactory resolving performance.

Further, the image pickup lens of the present invention, which satisfies mathematical expression (1), can achieve both a wide angle of view and satisfactory resolving performance in an area surrounding a shot image.

An image pickup lens whose f2/f1 is less than or equal to −3.6 has a wider angle of view due to a shorter focal length, but increases in various aberrations due to too wide an angle of view, thus making it difficult to secure satisfactory resolving performance. Therefore, such an image pickup lens is not preferable.

An image pickup lens whose f2/f1 is greater than or equal to −2.5 has a narrower angle of view due to a longer focal length to become insufficient to achieve satisfactory resolving performance in an area surrounding a shot image. Therefore, such an image pickup lens is not preferable.

An image pickup lens whose first lens and/or second lens have Abbe numbers of less than or equal to 45 increases in chromatic aberrations to make it difficult to achieve satisfactory resolving performance. Therefore, such an image pickup lens is not preferable.

Further, an image pickup module of the present invention includes: any one of the above image pickup lenses; and a solid-state image sensing device that receives as light an image formed by the image pickup lens.

According to the foregoing configuration, the image pickup module of the present invention brings about the same effects as the image pickup lens of the present invention that it includes.

The foregoing configuration allows the image pickup module of the present invention to achieve an inexpensive, compact, and high-performance image pickup module.

Further, a portable information device of the present invention includes any one of the above image pickup modules.

According to the foregoing configuration, the portable information device of the present invention brings about the same effects as the image pickup module of the present invention and, by extension, the image pickup lens of the present invention that it includes.

### Advantageous Effects of Invention

As described above, an image pickup lens of the present invention includes: an aperture stop; a first lens; and a second lens, the aperture stop, the first lens, and the second lens being sequentially arranged along a direction from an object to an image surface, the first lens being a meniscus lens having a positive refracting power and having a convex surface facing the object, the second lens being a lens having a negative refracting power, having a concave surface facing the object, and having a surface, facing the image surface, whose central portion has a concave shape, the first lens having an Abbe number of greater than 45, the second lens having an Abbe number of greater than 45, the image pickup lens satisfying mathematical expression (1):

−3.6<f2/f1<−2.5 (1)

where f1 is the focal length of the first lens and f2 is the focal length of the second lens.

This therefore brings about an effect of making it possible to reduce the risk of deterioration in optical characteristic by achieving satisfactory resolving performance in an area surrounding a shot image.

### BRIEF DESCRIPTION OF DRAWINGS

FIG. 1 is a cross-sectional view showing the configuration of an image pickup lens according to an embodiment of the present invention.

FIG. 2 shows graphs (a) through (c) showing the characteristics of various aberrations of the image pickup lens shown in FIG. 1, the graphs (a) through (c) showing a spherical aberration, astigmatism, and a distortion, respectively.

FIG. 3 shows: a graph (a) showing MTFs of the image pickup lens of FIG. 1 with respect to spatial frequency characteristics; and a graph (b) showing defocus MTFs of the same image pickup lens.

FIG. 4 is a cross-sectional view showing the configuration of a modification of the image pickup lens shown in FIG. 1.

FIG. 5 shows graphs (a) through (c) showing the characteristics of various aberrations of the image pickup lens shown in FIG. 4, the graphs (a) through (c) showing a spherical aberration, astigmatism, and a distortion, respectively.

FIG. 6 shows: a graph (a) showing MTFs of the image pickup lens of FIG. 4 with respect to spatial frequency characteristics; and a graph (b) showing defocus MTFs of the same image pickup lens.

FIG. 7 is a cross-sectional view showing the configuration of another modification of the image pickup lens shown in FIG. 1.

FIG. 8 shows graphs (a) through (c) showing the characteristics of various aberrations of the image pickup lens shown in FIG. 7, the graphs (a) through (c) showing a spherical aberration, astigmatism, and a distortion, respectively.

FIG. 9 shows: a graph (a) showing MTFs of the image pickup lens of FIG. 7 with respect to spatial frequency characteristics; and a graph (b) showing defocus MTFs of the same image pickup lens.

FIG. 10 is a cross-sectional view showing the configuration of still another modification of the image pickup lens shown in FIG. 1.

FIG. 11 shows graphs (a) through (c) showing the characteristics of various aberrations of the image pickup lens shown in FIG. 10, the graphs (a) through (c) showing a spherical aberration, astigmatism, and a distortion, respectively.

FIG. 12 shows: a graph (a) showing MTFs of the image pickup lens of FIG. 10 with respect to spatial frequency characteristics; and a graph (b) showing defocus MTFs of the same image pickup lens.

FIG. 13 shows cross-sectional views (a) through (d) showing an example of a method for manufacturing an image pickup lens and an image pickup module according to the present invention.

FIG. 14 shows cross-sectional views (a) through (d) showing another example of a method for manufacturing an image pickup lens and an image pickup module according to the present invention.

FIG. 15 is a cross-sectional view showing the configuration of a wire-bonding type of image pickup module of a focus adjustment-free structure using the image pickup lens shown in FIG. 1.

FIG. 16 is a cross-sectional view showing the configuration of a glass-on-wafer type of image pickup module of a focus adjustment-free structure using the image pickup lens shown in FIG. 1.

FIG. 17 is a cross-sectional view showing the configuration of another glass-on-wafer type of image pickup module of a focus adjustment-free structure using the image pickup lens shown in FIG. 1.

### DESCRIPTION OF EMBODIMENTS

[Specific Example of an Image Pickup Lens of the Present Invention]

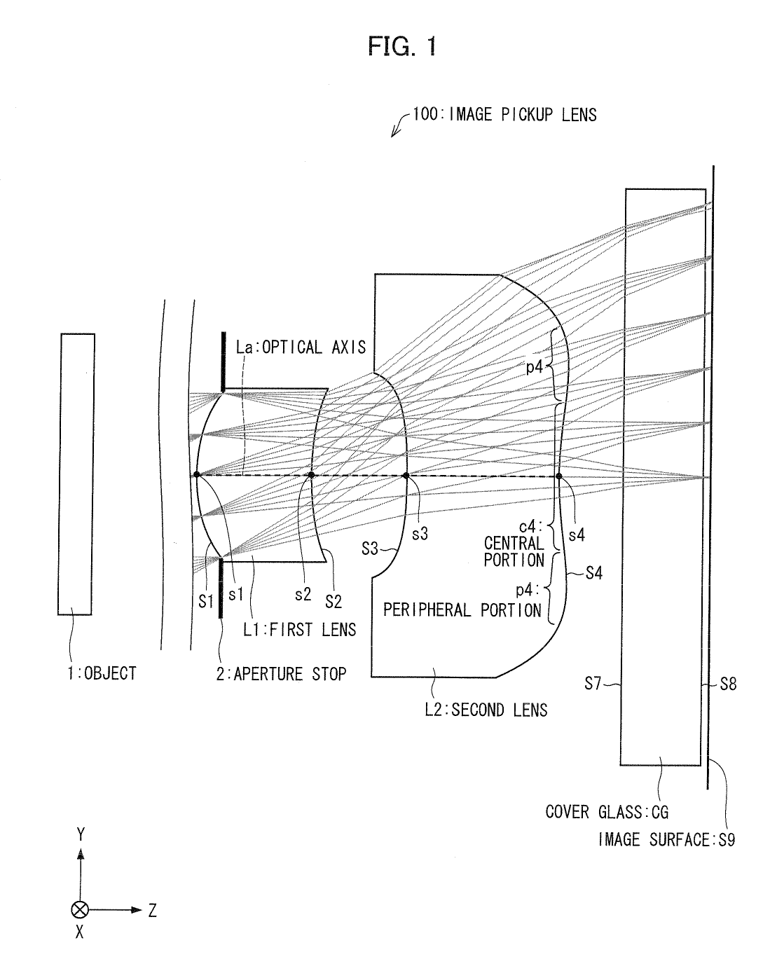

FIG. 1 shows a cross-section of an image pickup lens 100 along a Y direction (parallel up and down to the drawing) and a Z direction (parallel from side to side to the drawing) among three directions orthogonal to one another in space, namely an X direction (perpendicular to the drawing), the Y direction, and the Z direction.

The Z direction represents a direction from an object 1 to an image surface S9 (or a direction from the image surface S9 to the object 1). The image pickup lens 100 has its optical axis La extending substantially in parallel with the Z direction through the center s1 of that surface S1 (first-lens object-facing surface) of a first lens L1 which faces the object 1, the center s2 of that surface S2 (first-lens image-facing surface) of the first lens L1 which faces the image surface S9, the center s3 of that surface S3 (second-lens object-facing surface) of a second lens L2 which faces the object 1, and the center s4 of that surface S4 (second-lens image-facing surface) of the second lens L2 which faces the image surface S9. The direction of a line normal to the optical axis La of the image pickup lens 100 is a direction that extends straight from a point on the optical axis La to over a surface including the X direction and the Y direction.

The image pickup lens 100 includes an aperture stop 2, a first lens L1, a second lens L2, and a cover glass (image-surface protecting glass) CG with the aperture stop 2, the first lens L1, the second lens L2, and the cover glass CG sequentially arranged along the direction from the object 1 to the image surface S9.

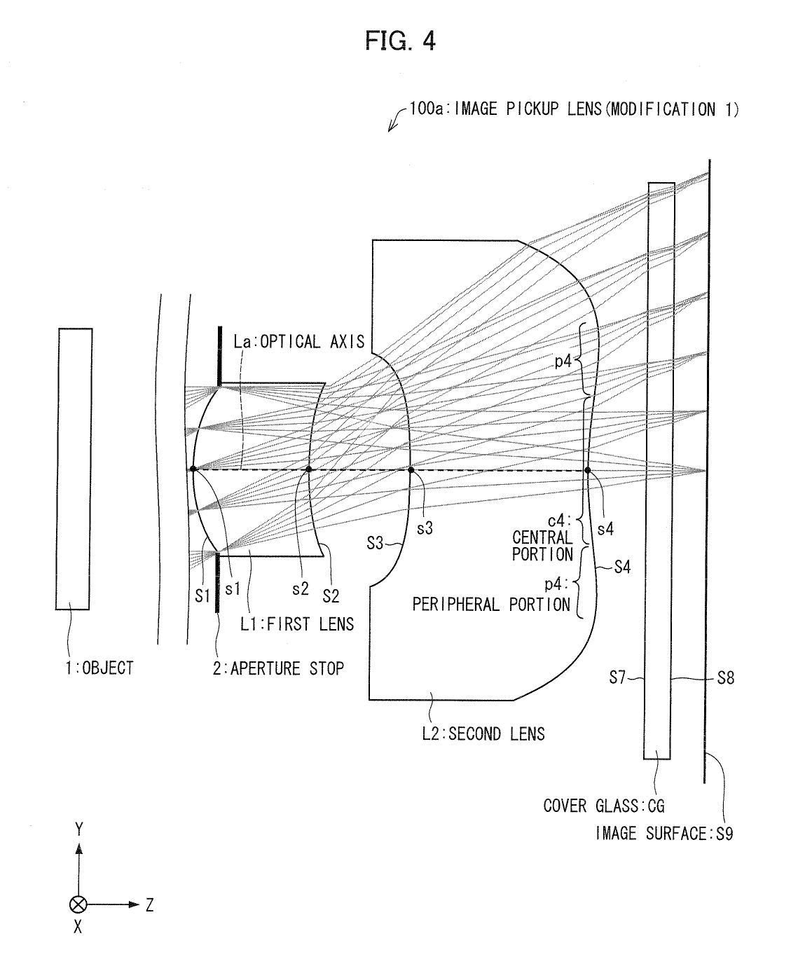

The object 1 is a physical object of which the image pickup lens 100 forms an image; in other words, the object 1 is a subject whose image is taken by the image pickup lens 100. For the sake of convenience, it is shown in FIG. 1 and, furthermore, FIGS. 4, 7, and 10, which will be described later, as if the object 1 and the image pickup lens are in very close proximity to each other. However, the actual distance between the object 1 and the image pickup lens is, for example, approximately 1,200 mm.

Specifically, the aperture stop 2 is provided in such a way as to surround that surface S1 of the first lens L1 which faces the object 1. The aperture stop 2 is provided for the purpose of limiting the diameter of a bundle of rays on the axis of light incident upon the image pickup lens 100 so that the incident light can properly pass through the first lens L1 and the second lens L2.

The first lens L1 is a well-known meniscus lens, having a positive refracting power, whose surface S1 is a convex surface facing the object 1. This makes it possible to increase the proportion of the whole length of the first lens L1 to the whole length of the image pickup lens 100 and makes it possible to make the focal length of the image pickup lens 100 as a whole long relative to the whole length of the image pickup lens 100, thus making it possible to reduce the size of and lower the height of the image pickup lens 100. It should be noted that that surface S2 of the first lens L1 which faces the image surface S9 is a concave surface.

The second lens L2 is a lens, having a negative refracting power, whose surface S3 is a concave surface facing the object 1. This makes it possible to reduce the Petzval sum (axial curvature of the image of a plane object produced by an optical system) while maintaining the refracting power of the second lens L2, thus making it possible to reduce astigmatism, field curvatures, and coma aberrations.

Further, that surface S4 of the second lens L2 which faces the image surface S9 includes: a central portion c4, having a concave shape, which corresponds to the center s4 and an area around the center s4; and a peripheral portion p4, having a convex shape, which surrounds the central portion c4. That is, the surface S4 of the second lens L2 can be interpreted as being a component having a point of inflection where there is a transition between the central portion c4, which sinks in, and the peripheral portion p4, which sticks out. This allows a ray of light that passes through the central portion c4 to become capable of forming an image in a place closer to the object 1 along the Z direction, and allows a ray of light that passes through the peripheral portion p4 to become capable of forming an image in a place closer to the image surface S9 along the Z direction. For this reason, the image pickup lens 100 can correct various aberrations such as field curvatures in accordance with the specific shapes, i.e., the concave shape of the central portion c4 and of the convex shape of the peripheral portion p4. It should be noted, however, that the peripheral portion p4 does not need to have a convex shape and may be substantially plane.

The term “convex surface of a lens” here means a place in the lens where its spherical surface is curved outward. The term “concave surface of a lens” here means a place in the lens that constitutes a hollow, i.e., an inwardly-curved portion of the lens.

Strictly speaking, the aperture stop 2 is provided so that the convex surface formed as part of the surface S1 of the first lens L1 sticks out from the aperture stop 2 toward the object 1. However, there are no particular limits on whether or not the convex surface sticks out from the aperture stop 2 toward the object 1. It is sufficient for the aperture stop 2 to be placed closer to the object 1 than the first lens L1 is.

The cover glass CG is interposed between the second lens L2 and the image surface S9. The cover glass CG covers the image surface S9 to protect the image surface S9 from physical damage, etc. The cover glass CG has a surface (object-facing surface) S7 facing the object 1 and a surface (image-facing surface) S8 facing the image surface S9.

The image surface S9 is a surface to which the optical axis La of the image pickup lens 100 is perpendicular and on which an image is formed. A real image can be observed on a screen (not shown) placed on the image surface S9. Further, an image pickup module (which will be described in detail later) including the image pickup lens 100 usually has an image sensing device placed on the image surface S9.

These are the basic components of an image pickup lens of the present invention.

Both the first lens L1 and the second lens L2 have Abbe numbers of greater than 45. Specifically, the Abbe number νd of each material constituting the first lens L1 and the second lens L2 on d-rays (at a wavelength of 587.6 nm) of the first lens L1 and the second lens L2 is greater than 45.

The term “Abbe number” here means a constant of an optical medium which expresses the ratio of a degree of refraction to dispersion of light. That is, the term “Abbe number” here means a degree of refraction of light of different wavelengths in different directions. A medium with a greater Abbe number disperses less depending on a degree of refraction of a ray of light at different wavelengths.

This allows the image pickup lens 100 to suppress chromatic aberrations (lens aberrations causing shifts in position and size of an image extending from one color to another) and therefore achieve satisfactory resolving performance.

On the other hand, in cases where the Abbe number of a material constituting the first lens L1 and/or the second lens L2 on d-rays of the first lens L1 and/or the second lens L2 is less than or equal to 45, the image pickup lens undesirably increases in chromatic aberrations to make it difficult to achieve satisfactory resolving performance.

Further, the image pickup lens 100 is configured to satisfy mathematical expression (1) as follows:

−3.6<f2/f1<−2.5 (1)

where f1 is the focal length of the first lens L1 and f2 is the focal length of the second lens L2.

The image pickup lens 100, which satisfies mathematical expression (1), can achieve both a wide angle of view and satisfactory resolving performance in an area surrounding a shot image.

On the other hand, in cases where f2/f1 is less than or equal to −3.6, the image pickup lens has a wider angle of view due to a shorter focal length, but increases in various aberrations due to too wide an angle of view, thus undesirably making it difficult to secure satisfactory resolving performance.

Alternatively, in cases where f2/f1 is greater than or equal to −2.5, the image pickup lens has a narrower angle of view due to a longer focal length, thus undesirably becoming insufficient to achieve satisfactory resolving performance in an area surrounding a shot image.

It is preferable that the image pickup lens 100 have an F number of less than 3. The term “F number” here means a kind of amount that represents the brightness of an optical system. The F number of an image pickup lens is expressed as a value obtained by dividing the equivalent focal length of the image pickup lens by the incident pupil diameter of the image pickup lens. An F number of less than 3 allows the image pickup lens 100 to brighten an formed image because of an increase in the amount of light that it receives and obtain a high resolving power because of satisfactory corrections to chromatic aberrations.

Because equalization of the Abbe numbers for the first lens L1 and the second lens L2 allows the first lens L1 and the second lens L2 to be made of the same material as each other, it becomes possible for the image pickup lens 100 to be achieved as an inexpensive image pickup lens with a reduction in cost of manufacturing.

Further, although described in detail later, it is preferable that the image pickup lens 100 be obtained by joining a first lens array of first lenses L1 and a second lens array of second lenses L2 and dividing the first lens array and the second lens array thus joined.

As a method for manufacturing an image pickup lens, a manufacturing process called a wafer-level lens process has been proposed in order to achieve a reduction in cost of manufacturing. The wafer-level lens process is a manufacturing process for manufacturing an image pickup lens by: molding or shaping a material to be molded such as a resin into a plurality of lenses to produce two lens arrays, namely first and second lens arrays; joining these arrays; and dividing the arrays thus joined into each separate image pickup lens. This manufacturing process makes it possible to batch-manufacture a large number of image pickup lenses in a short period of time, thus making it possible to reduce the cost of manufacturing image pickup lenses.

According to the foregoing configuration, because the image pickup lens 100 is an image pickup lens manufactured by the wafer-level lens process described above, it becomes possible for the image pickup lens 100 to be provided inexpensively with a reduction in cost of manufacturing.

It is preferable that at least either the first lens L1 or the second lens L2 be made of thermosetting resin or UV curable resin. The thermosetting resin is a resin that has a property of changing in state from a liquid to a solid under a predetermined amount of heat. The UV curable resin is a resin that has a property of changing in state from a liquid to a solid when irradiated with ultraviolet rays at a predetermined level of intensity.

By configuring the first lens L1 to be made of thermosetting resin or UV curable resin, a first lens array to be described later can be produced, in the step of manufacturing the image pickup lens 100, by molding the resin into a plurality of first lenses L1. Similarly, by configuring the second lens L2 to be made of thermosetting resin or UV curable resin, a second lens array to be described later can be produced, in the step of manufacturing the image pickup lens 100, by molding the resin into a plurality of second lenses L2.

Therefore, according to the foregoing configuration, the image pickup lens 100 can be manufactured by the wafer-level lens process, and as such, the image pickup lens 100 allows a reduction in cost of manufacturing and mass production and therefore can be provided inexpensively.

In addition, by configuring both the first lens L1 and the second lens L2 to be made of thermosetting resin or UV curable resin, the image pickup lens 100 is made able to be subjected to reflowing.

It should be noted, however, that the first lens L1 and the second lens L2 may be plastic lenses, glass lenses, or the like instead.

[Table 1] is a table showing a formula for designing an image pickup lens 100, i.e., data specifying the shape of an image pickup lens 100, and the properties of materials for elements constituting the image pickup lens 100.

TABLE 1

| | | | | | Center | Effective | Aspheric coefficients | | |
|---|---|---|---|---|---|---|---|---|---|
| Elements | Materials | | | Curvature | thickness | radius | Conic | | |
| Lens Nos. | Nd | νd | Surfaces | [mm⁻¹] | [mm] | [mm] | coefficient | A4 | A6 |
| L1 | 1.498 | 46 | S1 (stop) | 1.1557440 | 0.729 | 0.517 | 0.00000 | −0.0140147 | 0.19777912 |
| | | | S2 | 0.4701817 | 0.597 | 0.533 | 0.00000 | 0.36008786 | −2.3416595 |
| L2 | 1.498 | 46 | S3 | −0.2576193 | 0.999 | 0.663 | 0.00000 | −0.1427595 | −3.3972376 |
| | | | S4 | 0.0245187 | 0.350 | 1.298 | 0.00000 | 0.20197209 | −1.2900025 |
| CG | 1.516 | 64 | S7 | — | 0.500 | — | — | — | — |
| | | | S8 | — | 0.050 | — | — | — | — |
| Sensor | — | — | S9 | — | — | — | — | — | — |
| (image | | | | | | | | | |
| surface | | | | | | | | | |

| Elements | Materials | | | Aspheric coefficients | | | | |
|---|---|---|---|---|---|---|---|---|
| Lens Nos. | Nd | νd | Surfaces | A8 | A10 | A12 | A14 | A16 |
| L1 | 1.498 | 46 | S1 (stop) | −1.3345084 | 2.19962653 | 29.5785848 | −169.49315 | 269.832052 |
| | | | S2 | 23.7947654 | −89.059241 | 34.4231977 | 678.3018 | −1183.8567 |
| L2 | 1.498 | 46 | S3 | 16.5349989 | −34.264721 | −44.331506 | 286.987479 | −356.14027 |
| | | | S4 | 2.57399277 | −2.9125827 | 1.84151076 | −0.6052894 | 0.07826314 |
| CG | 1.516 | 64 | S7 | — | — | — | — | — |
| | | | S8 | — | | — | — | — |
| Sensor | — | — | S9 | — | — | — | — | — |
| (image | | | | | | | | |
| surface | | | | | | | | |

In the column “Elements” of [Table 1], L1, L2, CG, and Sensor (image surface) denote the first lens L1, the second lens L2, the cover glass CG, and a position corresponding to the image surface S9, respectively.

In the column “Materials” of [Table 1], Nd denotes the refractive index on d-rays (at a wavelength of 587.6 nm) of each of the materials respectively constituting the first lens L1, the second lens L2, and the cover glass CG, and νd denotes the Abbe number of each of the materials on d-rays (i.e., the Abbe number according to the present invention).

As shown in [Table 1], both the first lens L1 and the second lens L2 have Abbe numbers of 46, which is greater than 45.

The term “curvature”, which means the degree of being further from being a plane, means an inverse of the curvature radius. The term “center thickness” means the distance between the center of the corresponding surface and the center of the next surface toward the image surface along the optical axis La (see FIG. 1). The term “effective radius” means the radius of a circular region in a lens where the range of a beam of light can be regulated.

Each of the “Aspheric coefficients” means an ith aspheric coefficient Ai (where i is an even number of 4 or greater) in aspheric formula (2) for constituting an aspheric surface. In aspheric formula (2), Z is a coordinate on the optical axis (Z direction of FIG. 1), x is a coordinate on a line normal to the optical axis (X direction of FIG. 1), R is the curvature radius (inverse of the curvature), and K is the conic coefficient.

$$\begin{matrix}[ Math . 1 ] & \\ Z = \frac{{x}^{2} \times 1 / R}{1 + \sqrt{1 - ( 1 + K ) \times {x}^{2} \times 1 / R}} + {{\sum }_{i = 4} {A}_{i} \times {x}^{i}}_{( even number )} & ( 2 )\end{matrix}$$

[Table 2] is a table showing the focal length f1 of the first lens L1, the focal length f2 of the second lens L2, and the result of calculation of the value “f2/f1” of mathematical expression (1) in the image pickup lens 100.

TABLE 2

| | |
|---|---|
| f1/mm | 2.443 |
| f2/mm | −7.028 |
| f2/f1 | −2.9 |

As shown in [Table 2], the focal length f1 of the first lens L1 of the image pickup lens 100 is approximately 2.443 mm, and the focal length f2 of the second lens L2 of the image pickup lens 100 is approximately −7.028 mm. It should be noted here that a positive value taken on by the focal length of a lens means that the lens has a positive refracting power and that a negative value taken on by the focal length of a lens means that the lens has a negative refracting power.

Therefore, in the image pickup lens 100, the result of calculation of “f2/f1” is as follows: −7.028 mm/2.443 mm=approximately −2.9. This result is a value that satisfies the relationship shown in mathematical expression (1).

[Table 3] is a table showing an example of specifications of an image pickup module constituted by placing a sensor (solid-state image sensing device) on the image surface S9 with respect to the image pickup lens 100.

TABLE 3

| Sensor Applied | ⅕ type 2M | |
|---|---|---|
| | Pixel pitch/μm | 1.75 |
| | Size/mm | (D) 3.5, (H) 2.8, (V) 2.1 |
| F number | | 2.80 |
| Focal length/mm | | 2.897 |
| Angle of view/deg | D (diagonal) | 60.5 |
| | H (horizontal) | 50.0 |
| | V (vertical) | 38.4 |
| TV distortion/% | | −0.34 |
| Relative | h0.6 | 73.4 |
| illumination/% | h0.8 | 64.8 |
| | h1.0 | 45.7 |
| CRA/deg | h0.6 | 23.7 |
| | h0.8 | 26.0 |
| | h1.0 | 26.1 |

| | |
|---|---|
| Whole optical length (inclusive | 3.23 |
| of CG)/mm | |
| CG thickness/mm | 0.500 |

In the image pickup module, the sensor is provided for the purpose of receiving as light an image formed by the image pickup lens provided.

In the specifications shown in [Table 3], the sensor applied has a size of ⅕ type and 2M (mega) class. In this case, the sensor has a pixel count of greater than or equal to 1.3 million pixels. By thus selecting and using a sensor having 1.3 million or more pixels suited to the resolving performance of the image pickup lens, an image pickup module is made able to be achieved which has satisfactory resolving performance.

As shown in the item “Pixel pitch” on the specifications shown in [Table 3], the sensor has a pixel pitch of 1.75 μm, which is less than or equal to 2.5 μm. By thus using a sensor whose pixel pitch is less than or equal to 2.5 μm, an image pickup module is made able to be achieved which makes full use of the performance of a sensor having a large number of pixels. The pixel pitch corresponds to the size of pixels.

In the item “Size” on [Table 3], the size of the sensor is represented by three-dimensional parameters, namely D (diagonal), H (horizontal), and V (vertical).

As shown in the item “F number” on the specifications shown in [Table 3], the F number is favorably 2.80, which is less than 3.

The item “Focal length” on [Table 3] shows the focal length of the image pickup lens 100 as a whole.

The item “Angle of view” on [Table 3] shows an angle of view of the image pickup lens 100, i.e., each of the angles within which the image pickup lens 100 can form an image, which is represented by three-dimensional parameters, namely D (diagonal), H (horizontal), and V (vertical). According to [Table 3], the image pickup lens 100 has angles of view of 60.5 degrees at D (diagonal), 50.0 degrees at H (horizontal), and 38.4 degrees at V (vertical), which are satisfactory values (constitute a wide angle of view).

The item “Relative illumination” on [Table 3] shows the relative illumination (percentages of amounts of light to the amount of light at an image height h of 0) of the image pickup lens 100 at an image height h of 0.6, at an image height h of 0.8, and at an image height h of 1.0, respectively.

The term “image height” means the height of an image with reference to the center of the image. Moreover, the height of an image with respect to the maximum image height is expressed as a percentage. The image height is expressed as an image height h of 0.8 as above (or else may be sometimes expressed as eight-in-ten image height, h0.8, etc.) to indicate a place at an image height corresponding to 80% of the maximum image height with reference to the center of the image. The expressions “image height h of 0”, “image height h of 0.6”, and “image height h of 1.0” are similar in effect to the expression “image height h of 0.8”.

The item “CRA” on [Table 3] shows chief ray angles (CRAs) of the image pickup lens 100 at an image height h of 0.6, at an image height h of 0.8, and at an image height h of 1.0, respectively.

The item “Whole optical length (inclusive of CG)” on [Table 3] shows the distance in the image pickup lens 100 between a place in the aperture stop 2 that is made larger or smaller to let more or less light in and the image surface S9. That is, the whole optical length of an image pickup lens of the present invention means the total of dimensions along the optical axis of all components that have a certain influence on the optical characteristics.

The item “CG thickness” on [Table 3] shows the thickness of the cover glass CG along the optical axis.

Further, used as a simulation light source (not illustrated) to obtain the properties shown in [Table 3] was a white light weighed as follows (whose mix proportions of wavelengths constituting white had been adjusted as follows):
404.66 nm=0.13
435.84 nm=0.49
486.1327 nm=1.57
546.07 nm=3.12
587.5618 nm=3.18
656.2725 nm=1.51

Moreover, the values shown in [Table 3] are specifications corresponding to a case where the object distance is 1,200 mm. Let it be assumed that a simulation light source (white light) used to obtain properties shown in [Table 6], [Table 9], and [Table 12], which will be described later, is weighted with the same values as above. Further, [Table 6], [Table 9], and [Table 12], which will be described later, also shows specifications corresponding to cases where the object distance is 1,200 mm.

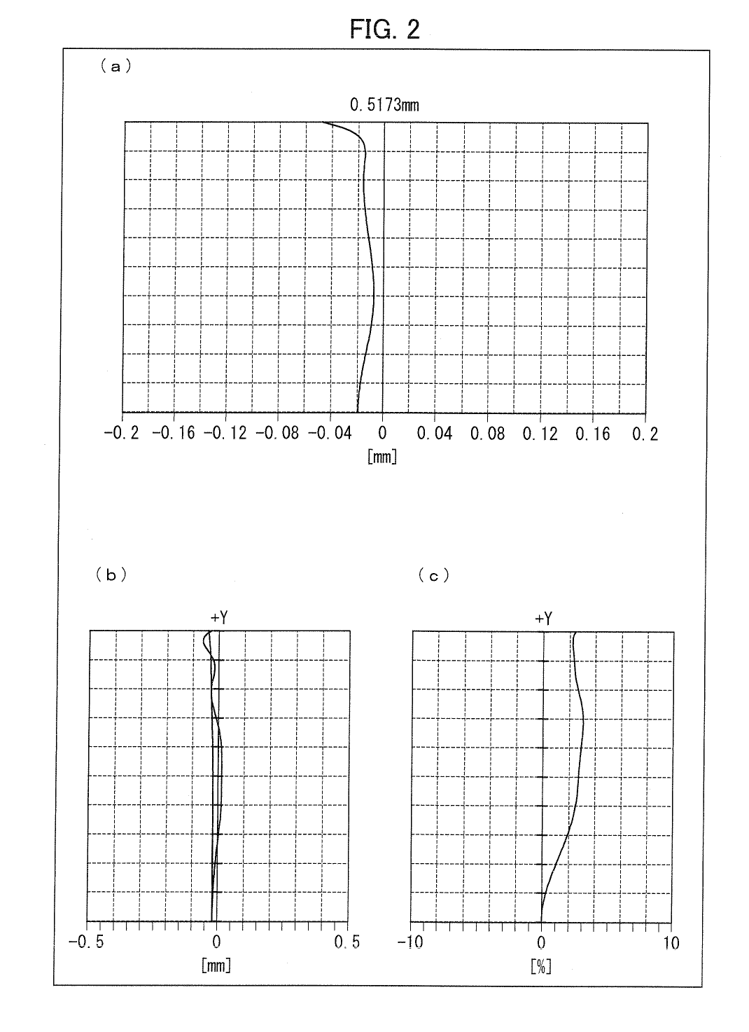

FIG. 2 shows graphs (a) through (c) showing the characteristics of various aberrations of the image pickup lens 100, the graphs (a) through (c) showing a spherical aberration, astigmatism, and a distortion, respectively.

The graphs (a) through (c) of FIG. 2 show, from the small amounts of remaining aberrations (small shifts in magnitude of each aberration along a direction normal to the optical axis La), that the image pickup lens 100 has satisfactory optical characteristics.

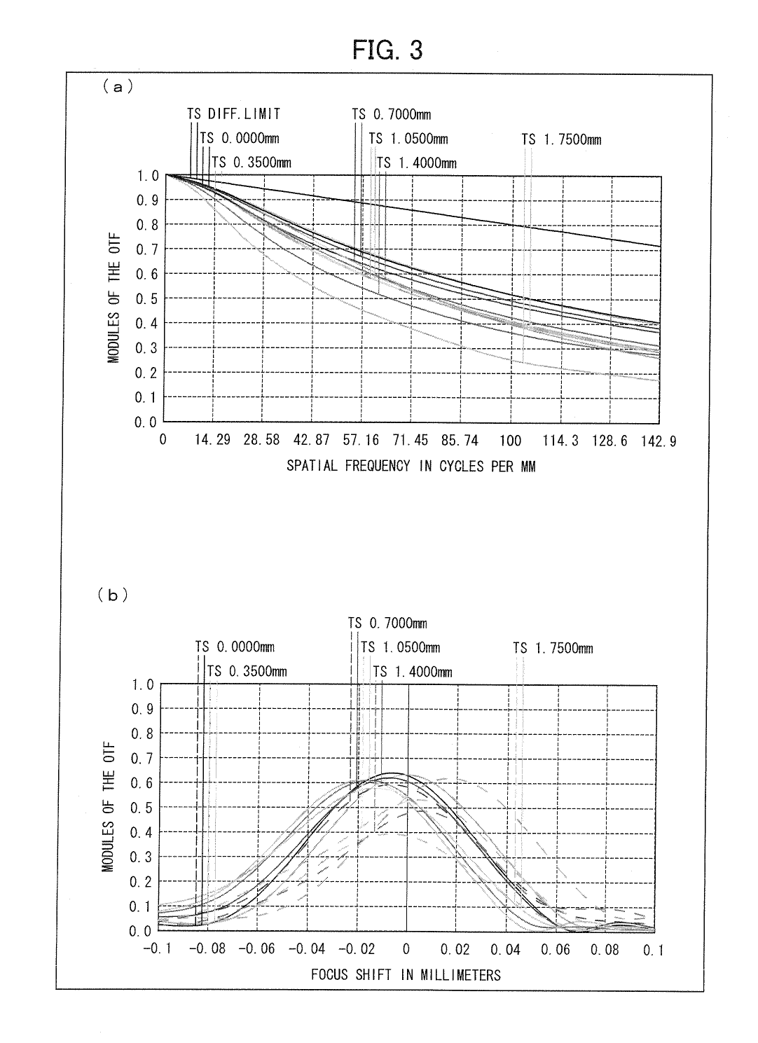

(a) of FIG. 3 shows MTFs (modulation transfer functions) of the image pickup lens 100 with respect to spatial frequency characteristics.

In the graph shown in (a) of FIG. 3, the vertical axis represents the value of MTF (unit: none), and the horizontal axis represents spatial frequency (unit: 1 p/mm). The image pickup lens 100 exhibits a high MTF characteristic of approximately 0.2 or higher with respect to spatial frequency.

(b) of FIG. 3 shows defocus MTFs, i.e., changes in MTF of the image pickup lens 100 with respect to positions on (displacements of) the image surface S9.

In the graph shown in (b) of FIG. 3, the vertical axis represents the value of MTF, and the horizontal axis represents focus shift amount (unit: mm). The image pickup lens 100 gives such satisfactory defocus characteristics that the locations of best image surface as indicated by maximum values of MTF are all present as positions where substantially the same levels of focus shift amount are exhibited.

[Modification 1]

FIG. 4 shows an image pickup lens 100a, which is a modification of the image pickup lens 100 shown in FIG. 1. The image pickup lens 100a has a thinner cover glass CG than does the image pickup lens 100 shown in FIG. 1. As for the other basic components, the image pickup lens 100a schematically has the same components as does the image pickup lens 100 shown in FIG. 1.

As with [Table 1], [Table 4] is a table showing a formula for designing an image pickup lens 100a, i.e., data specifying the shape of an image pickup lens 100a, and the properties of materials for elements constituting the image pickup lens 100a.

TABLE 4

| | | | | | Center | Effective | Aspheric coefficients | | |
|---|---|---|---|---|---|---|---|---|---|
| Elements | Materials | | | Curvature | thickness | radius | Conic | | |
| Lens Nos. | Nd | νd | Surfaces | [mm⁻¹] | [mm] | [mm] | coefficient | A4 | A6 |
| L1 | 1.498 | 46 | S1 (stop) | 1.2627305 | 0.681 | 0.481 | 0.00000 | −0.0821411 | 2.05870374 |
| | | | S2 | 0.5753552 | 0.545 | 0.493 | 0.00000 | 0.67313625 | −6.350606 |
| L2 | 1.498 | 46 | S3 | −0.1780286 | 1.105 | 0.683 | 0.00000 | −0.691299 | 2.4893531 |
| | | | S4 | 0.1251407 | 0.309 | 1.372 | 0.00000 | 0.05027203 | −0.6946082 |
| CG | 1.516 | 64 | S7 | — | 0.145 | — | — | — | — |
| | | | S8 | — | 1.195 | — | — | — | — |
| Sensor | — | — | S9 | — | — | — | — | — | — |
| (image | | | | | | | | | |
| surface | | | | | | | | | |

| Elements | Materials | | | Aspheric coefficients | | | | |
|---|---|---|---|---|---|---|---|---|
| Lens Nos. | Nd | νd | Surfaces | A8 | A10 | A12 | A14 | A16 |
| L1 | 1.498 | 46 | S1 (stop) | −18.724694 | 53.1400333 | 225.311883 | −1674.3771 | 2778.3174 |
| | | | S2 | 77.2690666 | −407.5223 | 947.780538 | −109.48553 | −1633.7649 |
| L2 | 1.498 | 46 | S3 | −9.0066101 | −25.089098 | 257.877687 | −657.88528 | 552.642888 |
| | | | S4 | 1.43714463 | −1.6824082 | 1.09518763 | −0.3709383 | 0.05026588 |
| CG | 1.516 | 64 | S7 | — | — | — | — | — |
| | | | S8 | — | — | — | — | — |
| Sensor | — | — | S9 | — | — | — | — | — |
| (image | | | | | | | | |
| surface | | | | | | | | |

As shown in [Table 4], both the first lens L1 and the second lens L2 have Abbe numbers of 46, which is greater than 45.

As with [Table 2], [Table 5] is a table showing the focal length f1 of the first lens L1, the focal length f2 of the second lens L2, and the result of calculation of the value “f2/f1” of mathematical expression (1) in the image pickup lens 100a.

TABLE 5

| | |
|---|---|
| f1/mm | 2.344 |
| f2/mm | −6.416 |
| f2/f1 | −2.7 |

As shown in [Table 5], the focal length f1 of the first lens L1 of the image pickup lens 100a is approximately 2.344 mm, and the focal length f2 of the second lens L2 of the image pickup lens 100a is approximately −6.416 mm.

Therefore, in the image pickup lens 100a, the result of calculation of “f2/f1” is as follows: −6.416 mm/2.344 mm=approximately −2.7. This result is a value that satisfies the relationship shown in mathematical expression (1).

As with [Table 3], [Table 6] is a table showing an example of specifications of an image pickup module constituted by placing a sensor (solid-state image sensing device) on the image surface S9 with respect to the image pickup lens 100a.

TABLE 6

| Sensor Applied | ⅕ type 2M | |
|---|---|---|
| | Pixel pitch/μm | 1.75 |
| | Size/mm | (D) 3.5, (H) 2.8, (V) 2.1 |
| F number | | 2.80 |
| Focal length/mm | | 2.692 |
| Angle of view/deg | D (diagonal) | 62.3 |
| | H (horizontal) | 51.7 |
| | V (vertical) | 39.8 |
| TV distortion/% | | −0.07 |
| Relative | h0.6 | 70.8 |
| illumination/% | h0.8 | 59.2 |
| | h1.0 | 45.6 |
| CRA/deg | h0.6 | 25.4 |
| | h0.8 | 26.9 |
| | h1.0 | 26.1 |

| | |
|---|---|
| Whole optical length (inclusive | 2.98 |
| of CG)/mm | |
| CG thickness/mm | 0.145 |

What is worth noting in [Table 6] in relation to [Table 3] is the wide difference in “CG thickness” between 0.500 mm (Table 3) and 0.145 mm (Table 6). That is, whereas the thickness of the cover glass CG of the image pickup lens 100 along the optical axis is 0.500 mm, the thickness of the cover glass CG of the image pickup lens 100a along the optical axis is 0.145 mm, which means that the image pickup lens 100a is thinner than the image pickup lens 100.

The image pickup lens 100a, whose cover glass CG is thin, brings about the following advantages.

That is, the thin cover glass CG allows the image surface S9 to be located away from the cover glass CG along the optical axis. This means, in other words, that in an image pickup module having a sensor placed on the image surface S9, the sensor is located away from the cover glass CG along the optical axis.

By placing the cover glass CG and the sensor at a certain distance from each other along the optical axis, the image pickup module is made able to be applied to both a wire-bonding structure and a glass-on-wafer structure. Specifically, in cases where the distance between the cover glass CG and the sensor is less than 0.195 mm, the cover glass CG may interfere with a wire that makes an electrical connection between the sensor and a substrate, which makes it difficult for the image pickup module to be applied to a wire-bonding structure. With this taken into consideration, it is preferable that the distance between the cover glass CG and the sensor be greater than or equal to 0.195 mm. Moreover, in order to ensure that the distance between the cover glass CG and the sensor be greater than or equal to 0.195 mm, it can be said to be useful to form as thin a cover glass CG as that of the image pickup lens 100a.

In the specifications shown in [Table 6], the sensor applied has a size of ⅕ type and 2M (mega) class. In this case, the sensor has a pixel count of greater than or equal to 1.3 million pixels. By thus selecting and using a sensor having 1.3 million or more pixels suited to the resolving performance of the image pickup lens, an image pickup module is made able to be achieved which has satisfactory resolving performance.

As shown in the item “Pixel pitch” on the specifications shown in [Table 6], the sensor has a pixel pitch of 1.75 μm, which is less than or equal to 2.5 μm. By thus using a sensor whose pixel pitch is less than or equal to 2.5 μm, an image pickup module is made able to be achieved which makes full use of the performance of a sensor having a large number of pixels. The pixel pitch corresponds to the size of pixels.

As shown in the item “F number” on the specifications shown in [Table 6], the F number is favorably 2.80, which is less than 3.

The item “Angle of view” on [Table 6] shows an angle of view of the image pickup lens 100a, i.e., each of the angles within which the image pickup lens 100a can form an image, which is represented by three-dimensional parameters, namely D (diagonal), H (horizontal), and V (vertical). According to [Table 6], the image pickup lens 100a has angles of view of 62.3 degrees at D (diagonal), 51.7 degrees at H (horizontal), and 39.8 degrees at V (vertical), which are satisfactory values (constitute a wide angle of view).

The definition of each item on [Table 4] to [Table 6] and the way of looking at [Table 4] to [Table 6] are the same as in [Table 1] to [Table 3], respectively, and are therefore not further explained in detail.

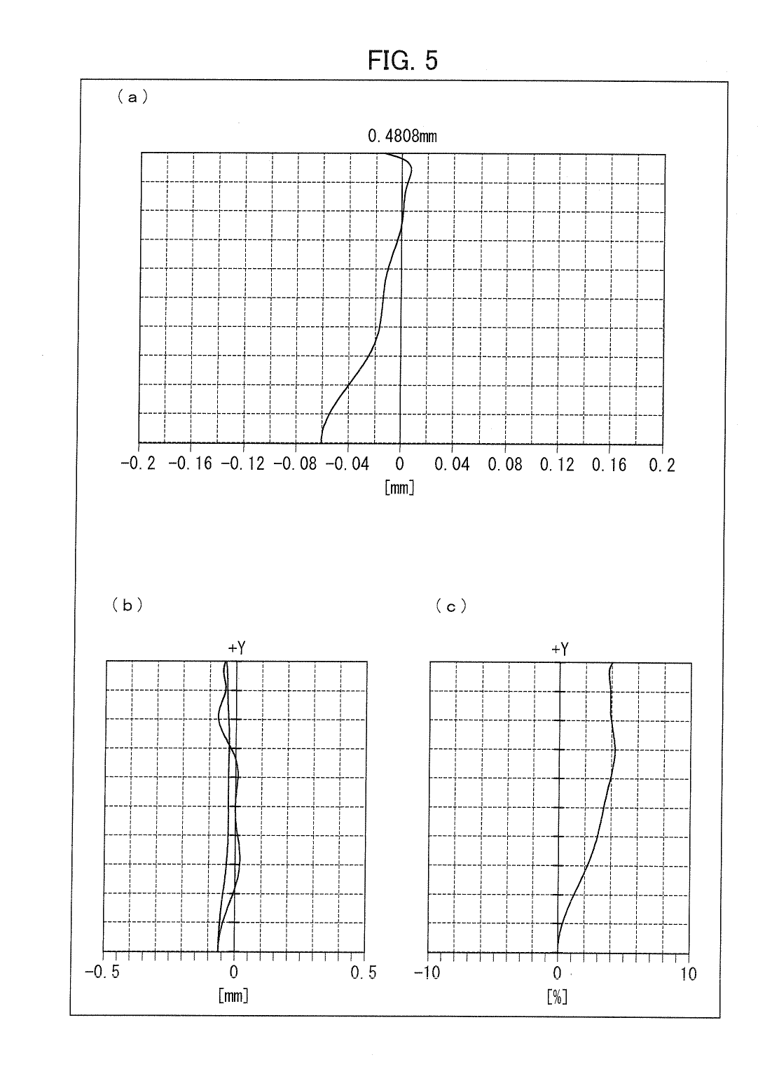

FIG. 5 shows graphs (a) through (c) showing the characteristics of various aberrations of the image pickup lens 100a, the graphs (a) through (c) showing a spherical aberration, astigmatism, and a distortion, respectively.

The graphs (a) through (c) of FIG. 5 show, from the small amounts of remaining aberrations (small shifts in magnitude of each aberration along a direction normal to the optical axis La), that the image pickup lens 100a has satisfactory optical characteristics.

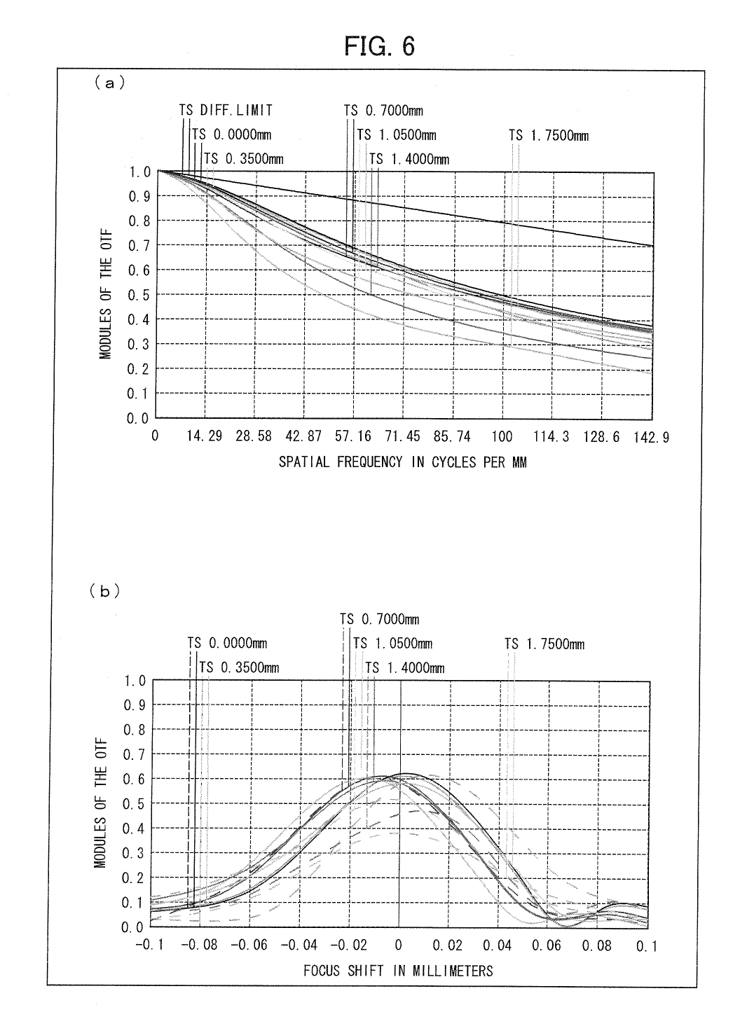

(a) of FIG. 6 shows MTFs of the image pickup lens 100a with respect to spatial frequency characteristics.

In the graph shown in (a) of FIG. 6, the vertical axis represents the value of MTF (unit: none), and the horizontal axis represents spatial frequency (unit: 1 p/mm). The image pickup lens 100a exhibits a high MTF characteristic of approximately 0.2 or higher with respect to spatial frequency.

(b) of FIG. 6 shows defocus MTFs, i.e., changes in MTF of the image pickup lens 100a with respect to positions on (displacements of) the image surface S9.

In the graph shown in (b) of FIG. 6, the vertical axis represents the value of MTF, and the horizontal axis represents focus shift amount (unit: mm). The image pickup lens 100a gives such satisfactory defocus characteristics that the locations of best image surface as indicated by maximum values of MTF are all present as positions where substantially the same levels of focus shift amount are exhibited.

[Modification 2]

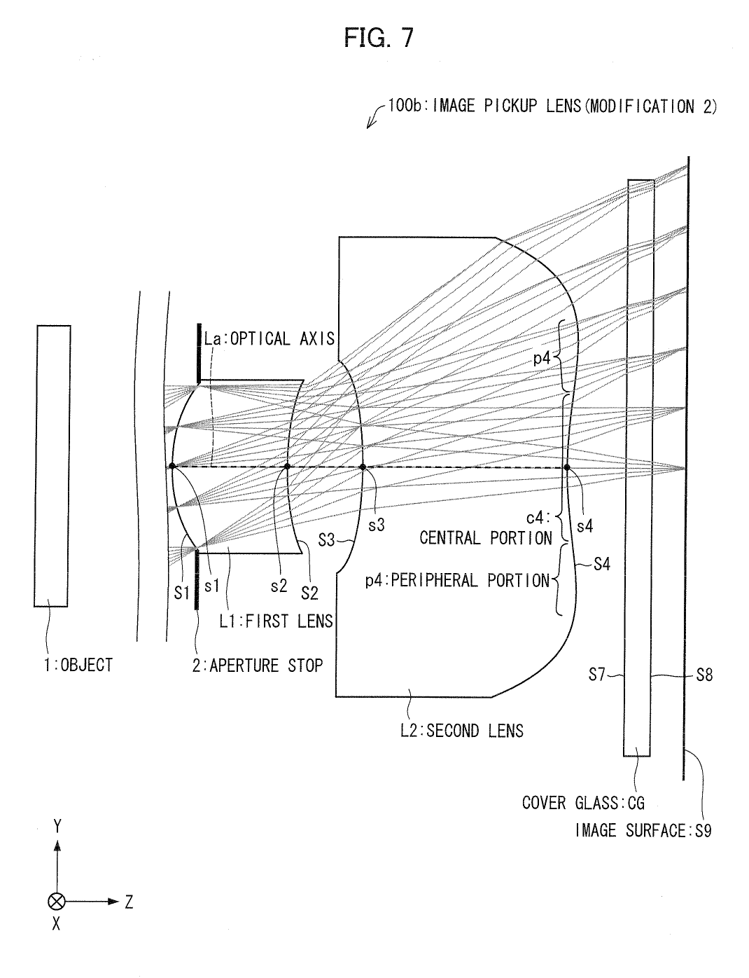

FIG. 7 shows an image pickup lens 100b, which is a modification of the image pickup lens 100 shown in FIG. 1. The image pickup lens 100b has a thinner cover glass CG than does the image pickup lens 100 shown in FIG. 1. As for the other basic components, the image pickup lens 100b schematically has the same components as does the image pickup lens 100 shown in FIG. 1.

As with [Table 1], [Table 7] is a table showing a formula for designing an image pickup lens 100b, i.e., data specifying the shape of an image pickup lens 100b, and the properties of materials for elements constituting the image pickup lens 100b.

TABLE 7

| | | | | | Center | Effective | Aspheric coefficients | | |
|---|---|---|---|---|---|---|---|---|---|
| Elements | Materials | | | Curvature | thickness | radius | Conic | | |
| Lens Nos. | Nd | νd | Surfaces | [mm⁻¹] | [mm] | [mm] | coefficient | A4 | A6 |
| L1 | 1.498 | 46 | S1 (stop) | 1.3072603 | 0.667 | 0.466 | 0.00000 | −0.0656502 | 1.69694886 |
| | | | S2 | 0.5883079 | 0.421 | 0.481 | 0.00000 | 0.63237732 | −5.9555737 |
| L2 | 1.498 | 46 | S3 | −0.2275235 | 1.186 | 0.627 | 0.00000 | −0.6177601 | 1.2478154 |
| | | | S4 | 0.0308947 | 0.316 | 1.348 | 0.00000 | 0.06714044 | −0.7032941 |
| CG | 1.516 | 64 | S7 | — | 0.145 | — | — | — | — |
| | | | S8 | — | 0.195 | — | — | — | — |
| Sensor | — | — | S9 | — | — | — | — | — | — |
| (image | | | | | | | | | |
| surface | | | | | | | | | |

| Elements | Materials | | | Aspheric coefficients | | | | |
|---|---|---|---|---|---|---|---|---|
| Lens Nos. | Nd | νd | Surfaces | A8 | A10 | A12 | A14 | A16 |
| L1 | 1.498 | 46 | S1 (stop) | −15.219049 | 46.1466885 | 156.696885 | −1303.1663 | 2285.89613 |
| | | | S2 | 79.6337287 | −443.49241 | 1156.7409 | −560.72087 | −1230.7819 |
| L2 | 1.498 | 46 | S3 | −7.4210521 | −8.0454206 | 228.519972 | −870.06881 | 1019.54844 |
| | | | S4 | 1.44009836 | −1.6795635 | 1.09391257 | −0.3731845 | 0.05115658 |
| CG | 1.516 | 64 | S7 | — | — | — | — | — |
| | | | S8 | — | — | — | — | — |
| Sensor | — | — | S9 | — | — | — | — | — |
| (image | | | | | | | | |
| surface | | | | | | | | |

As shown in [Table 7], both the first lens L1 and the second lens L2 have Abbe numbers of 46, which is greater than 45.

As with [Table 2], [Table 8] is a table showing the focal length f1 of the first lens L1, the focal length f2 of the second lens L2, and the result of calculation of the value “f2/f1” of mathematical expression (1) in the image pickup lens 100b.

TABLE 8

| | |
|---|---|
| f1/mm | 2.244 |
| f2/mm | −7.648 |
| f2/f1 | −3.4 |

As shown in [Table 8], the focal length f1 of the first lens L1 of the image pickup lens 100b is approximately 2.244 mm, and the focal length f2 of the second lens L2 of the image pickup lens 100b is approximately −7.648 mm.

Therefore, in the image pickup lens 100b, the result of calculation of “f2/f1” is as follows: −7.648 mm/2.244 mm=approximately −3.4. This result is a value that satisfies the relationship shown in mathematical expression (1).

As with [Table 3], [Table 9] is a table showing an example of specifications of an image pickup module constituted by placing a sensor (solid-state image sensing device) on the image surface S9 with respect to the image pickup lens 100b.

TABLE 9

| Sensor Applied | ⅕ type 2M | |
|---|---|---|
| | Pixel pitch/μm | 1.75 |
| | Size/mm | (D) 3.5, (H) 2.8, (V) 2.1 |
| F number | | 2.80 |
| Focal length/mm | | 2.612 |
| Angle of view/deg | D (diagonal) | 65.0 |
| | H (horizontal) | 54.0 |
| | V (vertical) | 41.7 |
| TV distortion/% | | −0.17 |
| Relative | h0.6 | 70.8 |
| illumination/% | h0.8 | 60.3 |
| | h1.0 | 43.5 |
| CRA/deg | h0.6 | 24.8 |
| | h0.8 | 27.0 |
| | h1.0 | 26.7 |

| | |
|---|---|
| Whole optical length (inclusive | 2.93 |
| of CG)/mm | |
| CG thickness/mm | 0.145 |

What is worth noting in [Table 9] in relation to [Table 3] is as follows: According to [Table 9], the image pickup lens 100b has angles of view of 65.0 degrees at D (diagonal), 54.0 degrees at H (horizontal), and 41.7 degrees at V (vertical), which are much more satisfactory values (constitute a wide angle of view) than those of the image pickup lens 100.

In the specifications shown in [Table 9], the sensor applied has a size of ⅕ type and 2M (mega) class. In this case, the sensor has a pixel count of greater than or equal to 1.3 million pixels. By thus selecting and using a sensor having 1.3 million or more pixels suited to the resolving performance of the image pickup lens, an image pickup module is made able to be achieved which has satisfactory resolving performance.

As shown in the item “Pixel pitch” on the specifications shown in [Table 9], the sensor has a pixel pitch of 1.75 μm, which is less than or equal to 2.5 μm. By thus using a sensor whose pixel pitch is less than or equal to 2.5 μm, an image pickup module is made able to be achieved which makes full use of the performance of a sensor having a large number of pixels. The pixel pitch corresponds to the size of pixels.

As shown in the item “F number” on the specifications shown in [Table 9], the F number is favorably 2.80, which is less than 3.

The definition of each item on [Table 7] to [Table 9] and the way of looking at [Table 7] to [Table 9] are the same as in [Table 1] to [Table 3], respectively, and are therefore not further explained in detail.

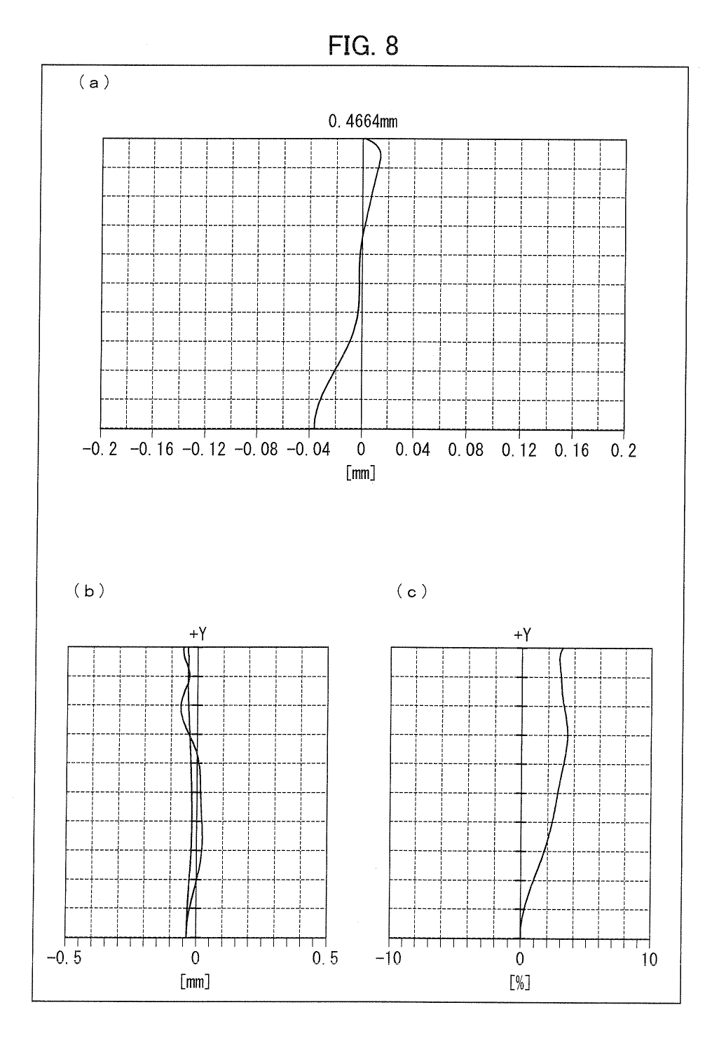

FIG. 8 shows graphs (a) through (c) showing the characteristics of various aberrations of the image pickup lens 100b, the graphs (a) through (e) showing a spherical aberration, astigmatism, and a distortion, respectively.

The graphs (a) through (c) of FIG. 8 show, from the small amounts of remaining aberrations (small shifts in magnitude of each aberration along a direction normal to the optical axis La), that the image pickup lens 100b has satisfactory optical characteristics.

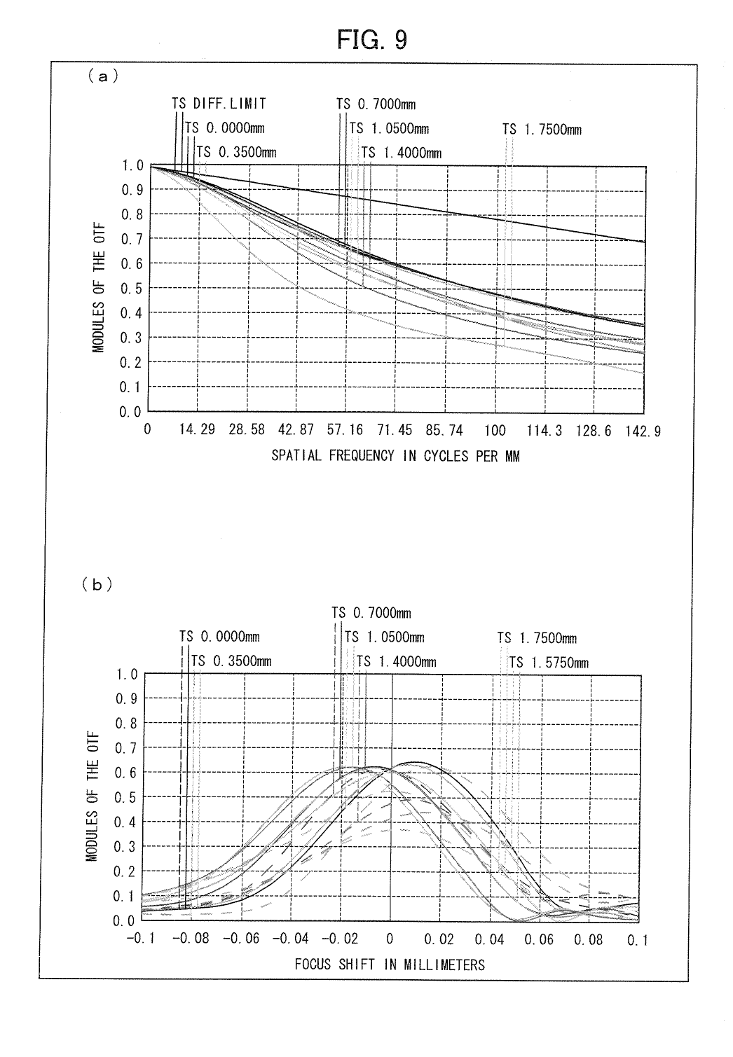

(a) of FIG. 9 shows MTFs of the image pickup lens 100b with respect to spatial frequency characteristics.

In the graph shown in (a) of FIG. 9, the vertical axis represents the value of MTF (unit: none), and the horizontal axis represents spatial frequency (unit: 1 p/mm). The image pickup lens 100b exhibits a high MTF characteristic of approximately 0.2 or higher with respect to spatial frequency.

(b) of FIG. 9 shows defocus MTFs, i.e., changes in MTF of the image pickup lens 100b with respect to positions on (displacements of) the image surface S9.

In the graph shown in (b) of FIG. 9, the vertical axis represents the value of MTF, and the horizontal axis represents focus shift amount (unit: mm). The image pickup lens 100b gives such defocus characteristics that the locations of best image surface as indicated by maximum values of MTF are present as scattered positions where different levels of focus shift amount are exhibited. The image pickup lens 100b is slightly inferior in defocus MTF to the image pickup lenses 100 and 100a.

In this way, the image pickup lens 100b has a wider angle of view but increases in various aberrations. The image pickup lens 100b shows an example of a case where its angle of view is as wide as possible. A wider angle of view than this is considered to be undesirable because it makes aberration correction difficult.

[Modification 3]

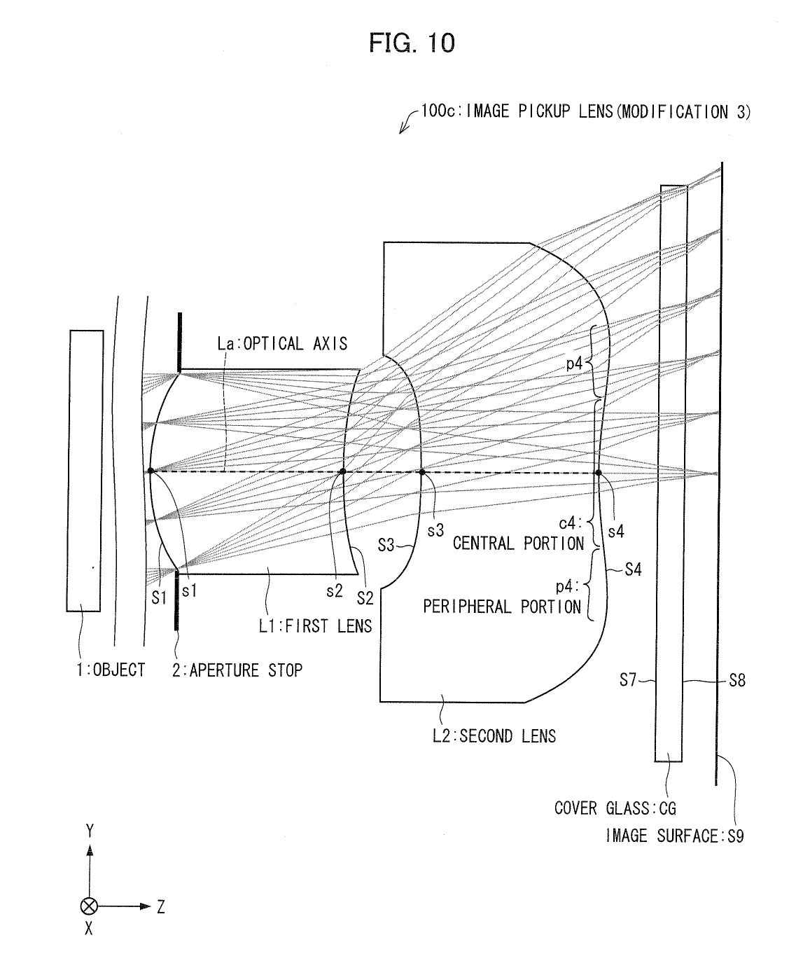

FIG. 10 shows an image pickup lens 100c, which is a modification of the image pickup lens 100 shown in FIG. 1. The image pickup lens 100c has a thinner cover glass CG than does the image pickup lens 100 shown in FIG. 1. As for the other basic components, the image pickup lens 100c schematically has the same components as does the image pickup lens 100 shown in FIG. 1.

As with [Table 1], [Table 10] is a table showing a formula for designing an image pickup lens 100c, i.e., data specifying the shape of an image pickup lens 100c, and the properties of materials for elements constituting the image pickup lens 100c.

TABLE 10

| | | | | | Center | Effective | Aspheric coefficients | | |
|---|---|---|---|---|---|---|---|---|---|
| Elements | Materials | | | Curvature | thickness | radius | Conic | | |
| Lens Nos. | Nd | νd | Surfaces | [mm⁻¹] | [mm] | [mm] | coefficient | A4 | A6 |
| L1 | 1.498 | 46 | S1 (stop) | 1.0395278 | 1.162 | 0.557 | 0.00000 | −0.1901134 | 3.1600974 |
| | | | S2 | 0.4013444 | 0.422 | 0.596 | 0.00000 | 0.51876617 | −7.3128024 |
| L2 | 1.498 | 46 | S3 | −0.3347368 | 1.080 | 0.678 | 0.00000 | −0.5325326 | 1.27299331 |
| | | | S4 | 0.0804798 | 0.394 | 1.346 | 0.00000 | 0.07270442 | −0.7262096 |
| CG | 1.516 | 64 | S7 | — | 0.145 | — | — | — | — |
| | | | S8 | — | 0.195 | — | — | — | — |
| Sensor | — | — | S9 | — | — | — | — | — | — |
| (image | | | | | | | | | |
| surface | | | | | | | | | |

| Elements | Materials | | | Aspheric coefficients | | | | |
|---|---|---|---|---|---|---|---|---|
| Lens Nos. | Nd | νd | Surfaces | A8 | A10 | A12 | A14 | A16 |
| L1 | 1.498 | 46 | S1 (stop) | −23.551551 | 44.0392751 | 265.717462 | −1333.3653 | 1671.80123 |
| | | | S2 | 72.0080962 | −360.27579 | 972.653059 | −1308.1356 | 707.654825 |
| L2 | 1.498 | 46 | S3 | −6.4411173 | −21.949996 | 253.363711 | −728.62343 | 684.451152 |
| | | | S4 | 1.43204101 | −1.6462124 | 1.08337601 | −0.3796392 | 0.05424432 |
| CG | 1.516 | 64 | S7 | — | — | — | — | — |
| | | | S8 | — | — | — | — | — |
| Sensor | — | — | S9 | — | — | — | — | — |
| (image | | | | | | | | |
| surface | | | | | | | | |

As shown in [Table 10], both the first lens L1 and the second lens L2 have Abbe numbers of 46, which is greater than 45.

As with [Table 2], [Table 11] is a table showing the focal length f1 of the first lens L1, the focal length f2 of the second lens L2, and the result of calculation of the value “f2/f1” of mathematical expression (1) in the image pickup lens 100c.

TABLE 11

| | |
|---|---|
| f1/mm | 2.498 |
| f2/mm | −4.701 |
| f2/f1 | −1.9 |

As shown in [Table 11], the focal length f1 of the first lens L1 of the image pickup lens 100c is approximately 2.498 mm, and the focal length f2 of the second lens L2 of the image pickup lens 100c is approximately −4.701 mm.

Therefore, in the image pickup lens 100c, the result of calculation of “f2/f1” is as follows: −4.701 mm/2.498 mm=approximately −1.9. This result is a value that does not satisfy the relationship shown in mathematical expression (1).

As with [Table 3], [Table 12] is a table showing an example of specifications of an image pickup module constituted by placing a sensor (solid-state image sensing device) on the image surface S9 with respect to the image pickup lens 100c.

TABLE 12

| Sensor Applied | ⅕ type 2M | |
|---|---|---|
| | Pixel pitch/μm | 1.75 |
| | Size/mm | (D) 3.5, (H) 2.8, (V) 2.1 |
| F number | | 2.80 |
| Focal length/mm | | 3.116 |
| Angle of view/deg | D (diagonal) | 54.7 |
| | H (horizontal) | 45.0 |
| | V (vertical) | 34.5 |
| TV distortion/% | | −0.06 |
| Relative | h0.6 | 76.1 |
| illumination/% | h0.8 | 68.8 |
| | h1.0 | 54.7 |
| CRA/deg | h0.6 | 24.1 |
| | h0.8 | 26.8 |
| | h1.0 | 27.0 |

| | |
|---|---|
| Whole optical length (inclusive | 3.40 |
| of CG)/mm | |
| CG thickness/mm | 0.145 |

What is worth noting in [Table 12] in relation to [Table 3] is as follows: According to [Table 12], the image pickup lens 100c has angles of view of 54.7 degrees at D (diagonal), 45.0 degrees at H (horizontal), and 34.5 degrees at V (vertical), which are vastly inferior to those of the image pickup lens 100 and constitute a very narrow angle of view.

In the specifications shown in [Table 12], the sensor applied has a size of ⅕ type and 2M (mega) class. In this case, the sensor has a pixel count of greater than or equal to 1.3 million pixels. By thus selecting and using a sensor having 1.3 million or more pixels suited to the resolving performance of the image pickup lens, an image pickup module is made able to be achieved which has satisfactory resolving performance.

As shown in the item “Pixel pitch” on the specifications shown in [Table 12], the sensor has a pixel pitch of 1.75 μm, which is less than or equal to 2.5 μm. By thus using a sensor whose pixel pitch is less than or equal to 2.5 μm, an image pickup module is made able to be achieved which makes full use of the performance of a sensor having a large number of pixels. The pixel pitch corresponds to the size of pixels.

As shown in the item “F number” on the specifications shown in [Table 12], the F number is favorably 2.80, which is less than 3.

The definition of each item on [Table 10] to [Table 12] and the way of looking at [Table 10] to [Table 12] are the same as in [Table 1] to [Table 3], respectively, and are therefore not further explained in detail.

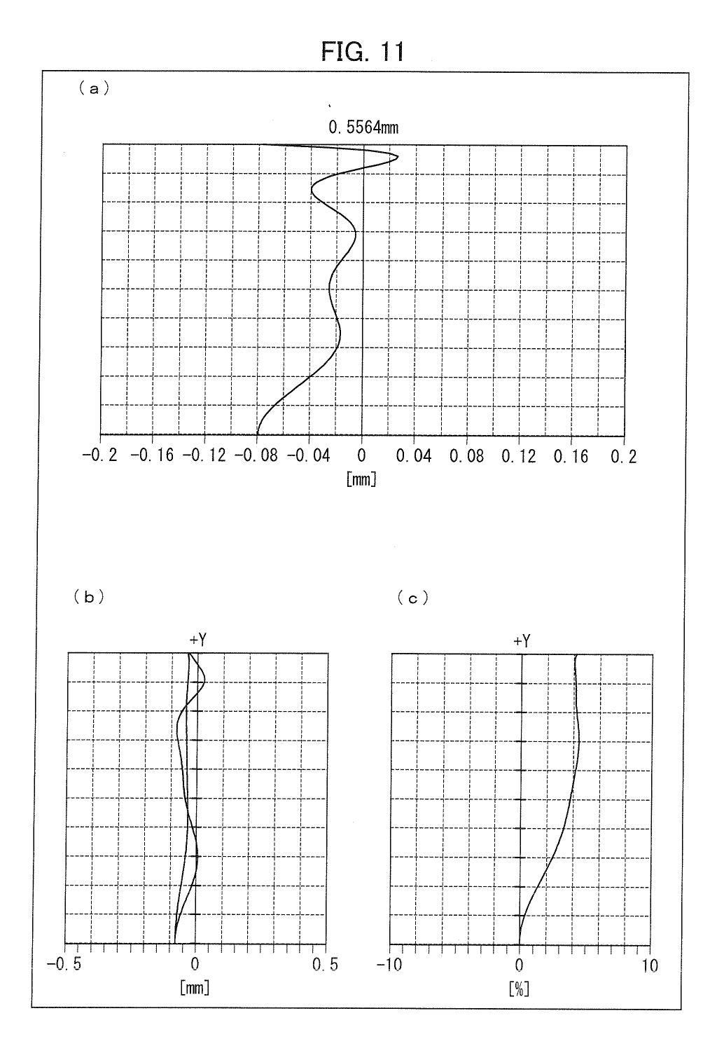

FIG. 11 shows graphs (a) through (c) showing the characteristics of various aberrations of the image pickup lens 100c, the graphs (a) through (c) showing a spherical aberration, astigmatism, and a distortion, respectively.

The graphs (a) through (c) of FIG. 11 show, from the small amounts of remaining aberrations (small shifts in magnitude of each aberration along a direction normal to the optical axis La), that the image pickup lens 100c has satisfactory optical characteristics.

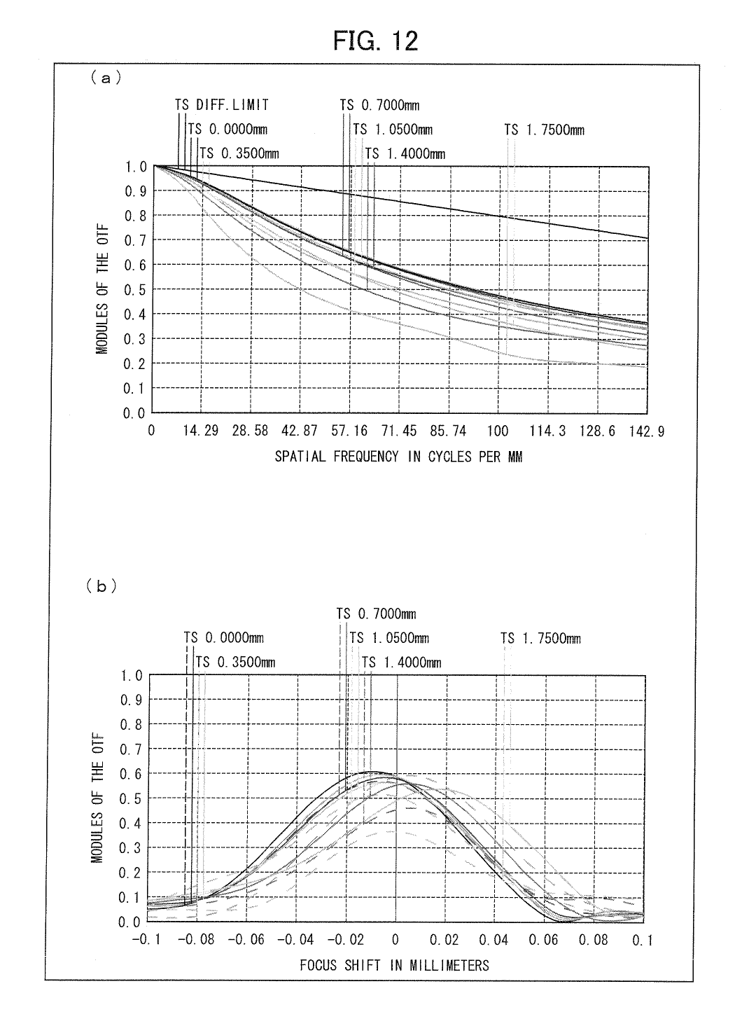

(a) of FIG. 12 shows MTFs of the image pickup lens 100c with respect to spatial frequency characteristics.

In the graph shown in (a) of FIG. 12, the vertical axis represents the value of MTF (unit: none), and the horizontal axis represents spatial frequency (unit: 1 p/mm). The image pickup lens 100c exhibits a high MTF characteristic of approximately 0.2 or higher with respect to spatial frequency.

(b) of FIG. 12 shows defocus MTFs, i.e., changes in MTF of the image pickup lens 100c with respect to positions on (displacements of) the image surface S9.

In the graph shown in (b) of FIG. 12, the vertical axis represents the value of MTF, and the horizontal axis represents focus shift amount (unit: mm). The image pickup lens 100c gives such satisfactory defocus characteristics that the locations of best image surface as indicated by maximum values of MTF are all present as positions where substantially the same levels of focus shift amount are exhibited.

In this way, the image pickup lens 100c has satisfactory resolving performance even in the surrounding area but becomes so narrow in angle of view as to be insufficient in angle of view in defiance of the specifications of an image pickup lens. Such a narrow angle of view is considered to be undesirable because it is insufficient to achieve satisfactory resolving performance in an area surrounding an image taken by a wide-angle image pickup lens.

[Example Method 1 for Manufacturing an Image Pickup Lens and an Image Pickup Module according to the Present Invention]

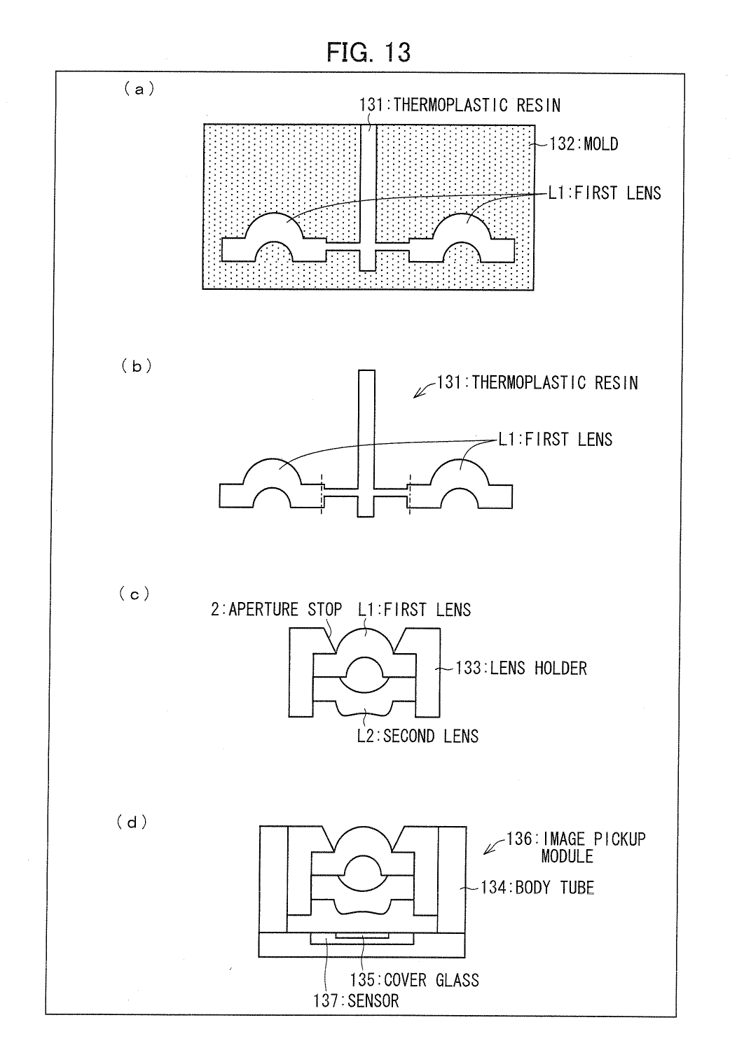

The following describes an example of a method for manufacturing an image pickup lens and an image pickup module according to the present invention with reference to (a) through (d) of FIG. 13.

The first lens L1 and the second lens L2 are produced mainly by injection molding with thermoplastic resin 131. Specifically, the first lens L1 and the second lens L2 are formed by softening the thermoplastic resin 131 by heat, forcing the thermoplastic resin 131 into a mold 132 at a predetermined injection pressure (approximately 10 to 3,000 kgf/c), and filling the mold 132 with the thermoplastic resin 131 (see (a) of FIG. 13). It should be noted that although, for convenience of explanation, (a) of FIG. 13 shows only the appearance of first lenses L1 being molded, a person skilled in the art can similarly mold second lenses L2 in conformity to the shape of a mold 132.

The thermoplastic resin 131 thus molded into a plurality of first lenses L1 is taken out from the mold 132, and then divided into each separate first lens L1 (see (b) of FIG. 13). Similarly, although not illustrated for convenience of explanation, the thermoplastic resin 131 thus molded into a plurality of second lenses L2 is taken out from the mold 132, and then divided into each separate second lens L2.

Each single first lens L1 thus divided from the other and each single second lens L2 thus divided from the other are fitted into or pressed into a lens holder 133 for assembly (see (c) of FIG. 13). In this example, the lens holder 133 has an aperture stop 2 (see FIG. 1) formed as part thereof. The intermediate product to be made into the image pickup module 136 shown in (c) of FIG. 13 can be used as an image pickup lens of the present invention.

The intermediate product to be made into the image pickup module 136 shown in (c) of FIG. 13 is fitted into a body tube 134 for assembly. After that, a sensor (solid-state image sensing device) 137 having a cover glass 135 attached to a light-receiving part thereof is mounted on the image surface S9 (see FIGS. 1, 4, 7, and 10) with respect to the image pickup lens including the first lens L1 and the second lens L2. Thus, the image pickup module 136 is completed (see (d) of FIG. 13).

The thermoplastic resin 131, of which the first lens L1 and the second lens L2, i.e. the injection molded lenses, are made, has a deflection temperature under loading (heat distortion temperature) of approximately 130° C. For this reason, the thermoplastic resin 131 is insufficient in resistance to a thermal history (whose maximum temperature is approximately 260° C.) during execution of reflowing, which is a technique that is applied mainly to surface mounting. Therefore, the thermoplastic resin 131 cannot resist heat that is generated during reflowing.

Consequently, whereas before the image pickup module 136 is mounted onto a substrate, only the sensor 137 section is mounted by reflowing; a method of joining the first lens L1 and second lens L2 section with resin or a mounting method of locally heating the area where the first lens L1 and second lens L2 are mounted is adopted.

It should be noted that since the cover glass 135 is contained in the sensor 137, it is graphically represented as a rectangle contained in the sensor 137. The image pickup module 136 shows an example of attachment of the cover glass 135 only to the light-receiving part of the sensor 137.

[Example Method 2 for Manufacturing an Image Pickup Lens and an Image Pickup Module according to the Present Invention]

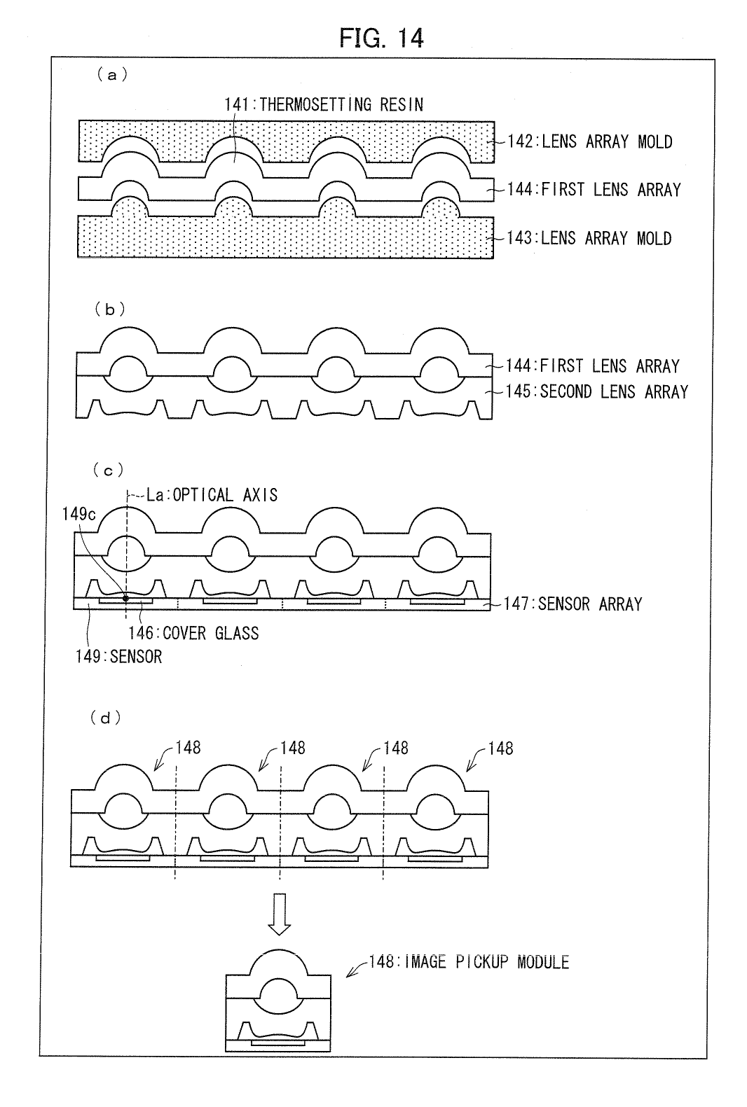

The following describes another example of a method for manufacturing an image pickup lens and an image pickup module according to the present invention with reference to (a) through (d) of FIG. 14. It should be noted that the method for manufacturing an image pickup lens and an image pickup module as shown in (a) through (d) of FIG. 14 corresponds to an example of a wafer-level lens process.

In recent years, the development of a so-called heat-resistant camera module whose first lens L1 and/or second lens L2 is/are made of thermosetting resin or UV curable resin has been advanced. The image pickup module 148 described here is such a heat-resistant camera module whose first lens L1 and second lens L2 are made of thermosetting resin 141, instead of being made of the thermoplastic resin 131 (see (a) of FIG. 13). It is possible to use UV curable resin instead of using the thermosetting resin 141.

A reason why the first lens L1 and/or second lens L2 is are made of the thermosetting resin 141 or the UV curable resin is to reduce the cost of manufacturing image pickup modules 148 by batch-manufacturing a large number of image pickup modules 148 in a short period of time. In particular, a reason why the first lens L1 and second lens L2 are made of the thermosetting resin 141 or the UV curable resin is to make it possible to perform reflowing on image pickup modules 148.

There have been proposed various techniques for manufacturing image pickup modules 148. Of these techniques, the aforementioned injection molding and the after-mentioned wafer-level lens process are representative. In particular, the wafer-level lens (reflowable lens) process has recently drawn attention as being more advantageous in terms of the time that it takes to manufacture image pickup modules and other comprehensive knowledge.

In the execution of the wafer-level lens process, it is necessary to prevent the first lens L1 and the second lens L2 from suffering from plastic deformation due to heat. Because of this necessity, wafer level lenses (lens arrays) made of a highly heat-resistant thermosetting resin material or UV curable resin material that resists deformation even under heat have drawn attention as the first lens L1 and the second lens L2. Specifically, wafer level lenses made of such a heat-resistant thermosetting resin material or UV curable resin material that does not suffer from plastic deformation even under heat of 260° C. to 280° C. for ten seconds or longer have drawn attention.

According to the wafer-level lens process, image pickup modules 148 are manufactured by batch-molding the thermosetting resin 141 into a first lens array 144 and a second lens array 145 with lens array molds 142 and 143, respectively, joining the first lens array 144 and the second lens array 145, mounting a sensor array 147, and then dividing an array of image pickup modules 148 into each separate image pickup module 148.

The following describes the details of the wafer-level lens process.

First, according to the wafer-level lens process, a lens array is produced by: sandwiching the thermosetting resin 141 between the lens array mold 142, which has a large number of concavities formed therein, and the lens array mold 143, which has a large number of convexities formed therein to correspond to the concavities; curing the thermosetting resin 141 by heat generated in the lens array molds 142 and 143; and molding a lens for each combination of each of the concavities and its corresponding one of the convexities (see (a) of FIG. 14).

The lens arrays that are produced in the step shown in (a) of FIG. 14 are the first lens array 144, which has a large number of first lenses L1 molded from the thermosetting resin 141 to be flush with one another, and the second lens array 145, which has a large number of second lenses L2 molded from the thermosetting resin 141 to be flush with one another.

In order to produce the first lens array 144 with the lens array molds 142 and 143 as shown in (a) of FIG. 14, it is only necessary to execute the step shown in (a) of FIG. 14 by using the lens array mold 142, which has a large number of concavities formed therein to be opposite in shape to the surface S1 (see FIG. 1) of a first lens L1, and the lens array mold 143, which has a large number of convexities formed therein to correspond to the concavities and to be opposite in shape to the surface S2 (see FIG. 1) of a first lens L1.

In order to produce the second lens array 145 with the lens array molds 142 and 143, although not illustrated for convenience of explanation, it is only necessary to execute the step shown in (a) of FIG. 14 by using the lens array mold 142, which has a large number of shapes formed therein to be opposite to the shape of the surface S4 (see FIG. 1) of a second lens L2 (i.e., of convex shapes each corresponding to the central portion c4 of the surface S4 and concave shapes each corresponding to the peripheral portion p4 of the surface S4), and the lens array mold 143, which has a large number of convexities formed therein to correspond to the shapes of a plurality of surfaces S4 and to be opposite in shape to the surface S3 (see FIG. 1) of a second lens L2.

The first lens array 144 and the second lens array 145 are joined so that the optical axis of each of the first lenses L1 and the optical axis of its corresponding second lens L2 are on the optical axis La (the same straight line) of the image pickup lens 100 shown in FIG. 1 (see (b) of FIG. 14). From the viewpoint of mass production of image pickup modules (including image pickup lenses), the first lens array 144 and the second lens array 145 are joined so that at least two combinations of the optical axis of a first lens L1 and the optical axis of its corresponding second lens L2 have their optical axes on different optical axes La from each other.

Specifically, examples of how the first lens array 144 and the second lens array 145 are aligned encompass various ways, such as making alignments while taking images, other than aligning the optical axis of a first lens L1 and the optical axis of a second lens L2 with each other on the optical axis La. Further, the alignment is affected by the pitch precision with which the wafer is finished.

Further, in so doing, it is possible to mount an aperture stop 2 (see FIG. 1) in such a way that a place corresponding to the surface S1 (see FIG. 1) of each first lens L1, i.e., each of the convexities of the first lens array 144 is exposed. However, there is no particular limit on the timing of mounting of an aperture stop 2 or on the way of mounting it.

On the combination of the first lens array 144 and the second lens array 145 shown in (b) of FIG. 14, the sensor array 147, which has a large number of sensors 149 integrally mounted, is mounted so that each optical axis La overlaps the center 149c of its corresponding sensor 149 (see (c) of FIG. 14). Each of the sensors 149 is placed on the image surface 89 (see FIGS. 1, 4, 7, and 10) of its corresponding image pickup lens 100 and, furthermore, has a cover glass 146 attached to a light-receiving part thereof.

In the step shown in (c) of FIG. 14, the array of a large number of image pickup modules 148 is divided into each single combination of the optical axis of a first lens L1 and the optical axis of its corresponding second lens L2, i.e., into each separate image pickup module 148 (at minimum into each single image pickup module 148), whereby the image pickup module 148 is completed (see (d) of FIG. 14).

It should be noted that since the cover glass 146 is contained in the sensor 149, it is graphically represented as a rectangle contained in the sensor 149. The image pickup module 148 shows an example of attachment of the cover glass 146 only to the light-receiving part of the sensor 149.

By omitting image sensing devices from image pickup modules 148, i.e., by omitting the step shown in (c) of FIG. 14 of mounting sensors 149 (sensor array 147) and mounting only cover glasses 146, the manufacture of image pickup lenses by the wafer-level lens process can be simplified.

However, there is no particular limit on the timing of mounting of cover glasses 135 and 146 or on the way of mounting them. In this way, the embodiment of provision of a cover glass (image-surface protecting glass) in an image pickup lens or an image pickup module of the present invention may be either the embodiments shown in FIG. 1 and the like or the embodiments shown in (d) of FIG. 13 and (d) of FIG. 14.

According to the wafer-level lens process shown above in (a) through (d) of FIG. 14, the cost of manufacturing image pickup modules 148 can be reduced by batch-manufacturing a large number of image pickup modules 148. Furthermore, in order to prevent the first lens L1 and the second lens L2 from suffering from plastic deformation due to heat (whose highest temperature is approximately 260° C.) that is generated by reflowing in mounting a completed image pickup module 148 on a substrate, it is more preferable that the first lens L1 and the second lens L2 be made of a heat-resistant thermosetting resin or UV curable resin that is resistant to heat of 260° C. to 280° C. for ten seconds or longer. This makes it possible to perform reflowing on the image pickup module 148. The application of a heat-resistant resin material to the wafer-level manufacturing steps makes it possible to inexpensively manufacture image pickup modules on which reflowing can be performed.

The following looks at materials, suitable to manufacturing image pickup modules 148, of which first lenses L1 and second lenses L2 can be made.

Conventionally, thermoplastic resin materials have been mainly used as materials for plastic lenses; therefore, there is a wide range of materials.

Meanwhile, thermosetting resin materials and UV curable resin materials have not been fully developed for use as first lenses L1 or second lenses L2 and, as such, are currently inferior to the thermoplastic resin materials in diversity and optical constant, and expensive. In general, the optical constant of a material with a low refractive index and low dispersivity is preferable. Further, it is preferable that there be a wide range of optical constants to choose from in optical design.

[Specific Example of an Image Pickup Module of the Present Invention]

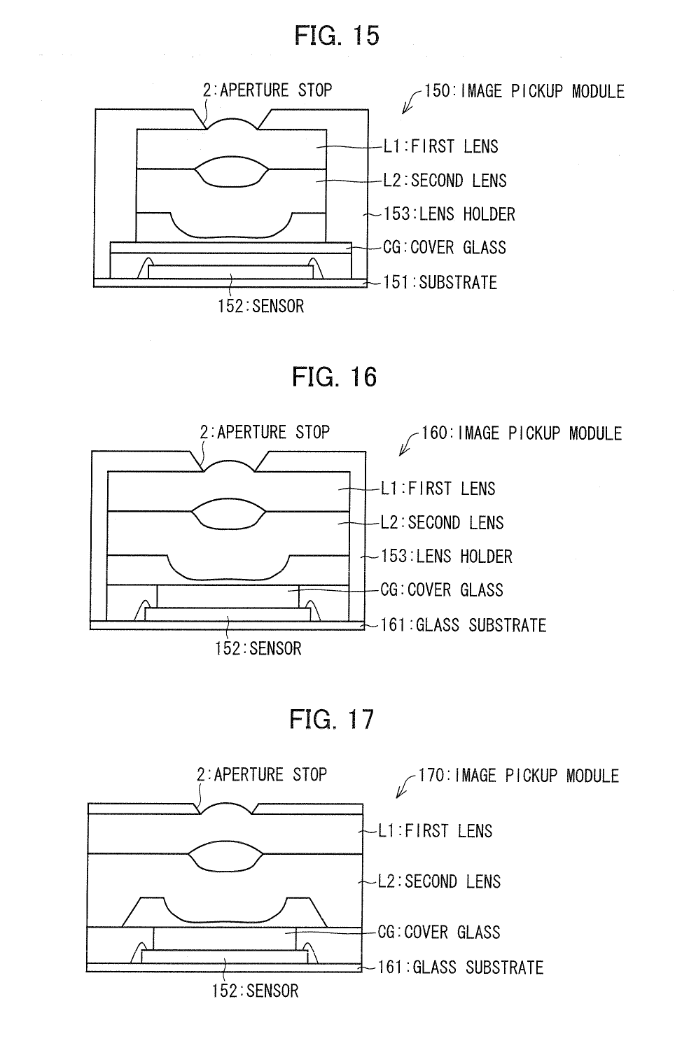

FIG. 15 is a cross-sectional view showing the configuration of a wire-bonding type of image pickup module 150 of a focus adjustment-free structure using an image pickup lens 100.

The image pickup module 150 includes an image pickup lens 100. Specifically, the image pickup module 150 includes an aperture stop 2, a first lens L1, a second lens L2, and a cover glass CG.

The image pickup module 150 includes a substrate 151. Provided on the substrate 151 is a sensor (solid-state image sensing device) 152 constituted by an electronic image sensing device or the like to receive as light an image formed by the image pickup lens 100. The sensor 152 is placed on the image surface S9 (see FIG. 1) of the image pickup lens 100, and it is preferable that its specifications be as shown in the item “Sensor applied” on each of [Table 3], [Table 6], [Table 9], and [Table 12]. That is, it is preferable that the sensor 152 have a pixel size of 2.5 μm or less and a pixel count of 1.3 million pixels (e.g., 2M class) or greater. The substrate 151 and the sensor 152 are connected to each other by a well-known wire bonding method.

The cover glass CG is provided between the second lens L2 and the sensor 152. In the case of the configuration of the image pickup module 150, it is preferable that the distance between the cover glass CG and the sensor 152 be greater than or equal to 0.195 mm.

Provided on the substrate 151 to cover the first lens L1, the second lens L2, the cover glass CG, and the sensor 152 is a lens holder 153.

FIG. 16 is a cross-sectional view showing the configuration of a glass-on-wafer type of image pickup module 160 of a focus adjustment-free structure using an image pickup lens 100.

Unlike the image pickup module 150 shown in FIG. 15, the image pickup module 160 shown in FIG. 16 shows an example of attachment of the cover glass CG only to the light-receiving part of the sensor 152. Further, the image pickup module 160 shown in FIG. 16 uses a glass substrate 161 instead of using the substrate 151.

Each of the image pickup modules 150 and 160 thus configured omits to include a mechanism for adjusting the focus position of the image pickup lens 100 and omits to include a body tube (see the body tube 134 shown in (d) of FIG. 13) for housing the first lens L1 and the second lens L2.

FIG. 17 is a cross-sectional view showing the configuration of a glass-on-wafer type of image pickup module 170 of a focus adjustment-free structure using an image pickup lens 100.

Unlike the image pickup module 160 shown in FIG. 16, the image pickup module 170 shown in FIG. 17 omits to include a lens holder 153. Further, the second lens L2 has its edge portion sticking out toward the image surface S9 (see FIG. 1) of the image pickup lens 100 and placed above the sensor 152, the cover glass CG, and the like.

The image pickup module 170 thus configured omits to include a mechanism for adjusting the focus position of the image pickup lens 100, omits to include a body tube (see the body tube 134 shown in (d) of FIG. 13) for housing the first lens L1 and the second lens L2, and omits to include a lens holder into which the first lens L1 and the second lens L2 are fitted.

The image pickup lens 100 has a feature of being excellent in tolerance sensitivity, i.e., of being wide in permissible range of various variations attributed to manufacturing variations and the like. This makes it unnecessary for the image pickup module 150, 160, or 170 to adjust the position of the sensor 152 with respect to the locations of best image surface along the optical axis, thus making it possible to omit a mechanism for adjusting the focus position of the image pickup lens 100, which mechanism has conventionally been required for adjusting the position of the sensor 152. Omission of such a mechanism makes it possible to reduce the cost of manufacturing image pickup modules 150, 160, and 170.

Further, according to the foregoing configuration, the omission of a body tube and/or a lens holder from the image pickup modules 150, 160, and 170 allows a reduction in the number of manufacturing steps and a reduction in the number of components and therefore allows a lower cost.

Although FIGS. 15 through 17 assume that their respective image pickup modules are each constituted by using an image pickup lens 100, an image pickup module of the present invention may be an image pickup module constituted by using an image pickup lens 100a or 100b.

Further, a portable information device of the present invention includes such an image pickup module of the present invention. According to this configuration, the portable information device of the present invention brings about the same effects as an image pickup module of the present invention and therefore an image pickup lens of the present invention. Examples of such a portable information device encompass various portable terminals such as information portable terminals and portable phones.

Further, the image pickup lens of the present invention may be configured to have an F number of less than 3.

According to the foregoing configuration, the image pickup lens of the present invention, which has an F number of less than 3 can increase the amount of light that it receives and obtain a high resolving power because of satisfactory corrections to chromatic aberrations.

Further, the image pickup lens may be configured to be obtained as a result of: preparing a first lens array including a plurality of said first lens flush with one another and a second lens array including a plurality of said second lens flush with one another; joining the first lens array and the second lens array so that at least two combinations of an optical axis of a first lens and an optical axis of a second lens corresponding to the first lens have their optical axes on different straight lines from each other; and then dividing the first lens array and the second lens array thus joined into each single one of said combinations of an optical axis of a first lens and an optical axis of a second lens corresponding to the first lens.

As a method for manufacturing an image pickup lens, a manufacturing process called a wafer-level lens process has been proposed in order to achieve a reduction in cost of manufacturing (see Patent Literatures 4 and 5). The wafer-level lens process is a manufacturing process for manufacturing an image pickup lens by: molding or shaping a material to be molded such as a resin into a plurality of lenses to produce two lens arrays (also referred to as “wafer lenses”), namely first and second lens arrays; joining these arrays; and dividing the arrays thus joined into each separate image pickup lens. This manufacturing process makes it possible to batch-manufacture a large number of image pickup lenses in a short period of time, thus making it possible to reduce the cost of manufacturing image pickup lenses.

According to the foregoing configuration, because the image pickup lens of the present invention is an image pickup lens manufactured by the wafer-level lens process described above, it becomes possible for the image pickup lens to be provided inexpensively with a reduction in cost of manufacturing.

Further, the image pickup lens of the present invention may be configured such that at least either the first lens or the second lens is made of a resin that is cured by heat or ultraviolet rays.

By configuring the first lens to be made of thermosetting resin or UV (ultraviolet) curable resin, a first lens array can be produced, in the step of manufacturing the image pickup lens of the present invention, by molding the resin into a plurality of first lenses. Similarly, by configuring the second lens to be made of thermosetting resin or UV curable resin, a second lens array can be produced, in the step of manufacturing the image pickup lens of the present invention, by molding the resin into a plurality of second lenses.

Therefore, according to the foregoing configuration, the image pickup lens of the present invention can be manufactured by the wafer-level lens process, and as such, the image pickup lens allows a reduction in cost of manufacturing and mass production and therefore can be provided inexpensively.

In addition, by configuring both the first lens and the second lens to be made of thermosetting resin or UV curable resin, the image pickup lens of the present invention is made able to be subjected to reflowing.

The foregoing configuration allows reflow mounting and therefore can achieve an image pickup lens low in cost of mounting and, by extension, an inexpensive image pickup lens. The image pickup lens of the present invention is so advantageous in terms of manufacturing tolerance as to have a large permissible amount with respect to a change in state of assembly of the image pickup lens as caused by heat generated during reflow mounting, and can therefore be applied even to a heavy-load process.

Further, the image pickup module of the present invention may be configured such that the solid-state image sensing device has a pixel size of 2.5 μm or less.

According to the foregoing configuration, by using a solid-state image sensing device whose pixel size is less than or equal to 2.5 μm, the image pickup modules of the present invention can be achieved as an image pickup module that makes full use of the performance of a solid-state image sensing device having a large number of pixels.

Further, the image pickup module of the present invention may be configured such that the solid-state image sensing device has a pixel count of 1.3 million pixels or greater.

According to the foregoing configuration, by selecting and using a solid-state image sensing device suited to the resolving performance of the image pickup lens, the image pickup modules of the present invention can be achieved as an image pickup module that has satisfactory resolving performance. In particular, the solid-state image sensing device according to the present invention is preferably of 2M (mega) class.

Further, the image pickup module of the present invention may be configured to further include an image-surface protecting glass for protecting the image surface of the image pickup lens, wherein the image-surface protecting glass and the solid-state image sensing device are at a distance of 0.195 mm or greater from each other.

According to the foregoing configuration, the image pickup module of the present invention can be applied to both a wire-bonding structure and a glass-on-wafer structure that are widely used in image pickup modules using solid-state image sensing devices. In an image pickup module in which the distance between the image-surface protecting glass and the solid-state image sensing device is less than 0.195 mm, the image-surface protecting glass may interfere with a wire that makes an electrical connection between the solid-state image sensing device and a substrate, which makes it difficult for the image pickup module to be applied to a wire-bonding structure.

Further, the image pickup module of the present invention may be configured to omit to include a mechanism for adjusting a focus position of the image pickup lens.

According to the foregoing configuration, the image pickup lens of the present invention has a feature of being excellent in tolerance sensitivity, i.e., of being wide in permissible range of various variations attributed to manufacturing variations and the like. This makes it unnecessary for the image pickup module of the present invention to adjust the position of the solid-state image sensing device with respect to the locations of best image surface along the optical axis, thus making it possible to omit a mechanism for adjusting the focus position of the image pickup lens, which mechanism has conventionally been required for adjusting the position of the solid-state image sensing device. Omission of such a mechanism makes it possible to reduce the cost of manufacturing image pickup modules of the present invention.

Further, the image pickup module of the present invention may be configured to omit to include a body tube that houses the first lens and the second lens.

Further, the image pickup module of the present invention may be configured to omit to include a lens holder into which the first lens and the second lens are fitted.

According to the foregoing configuration, the omission of a body tube and/or a lens holder from the image pickup module of the present invention allows a reduction in the number of manufacturing steps and a reduction in the number of components and therefore allows a lower cost.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be applied to image pickup lenses, image pickup modules, and portable information devices that are to be mounted into digital cameras, etc. of portable terminals. In particular, the present invention can be applied to: an image pickup module in which a solid-state image sensing device is used; an image pickup lens well-suited for application to such an image pickup module; and a portable information device including such an image pickup module.

### REFERENCE SIGNS LIST

1 Object
2 Aperture stop
L1 First lens
L2 Second lens
CG, 135, 146 Cover glass
S9 Image surface
100, 100a to 100c Image pickup lens
133, 153 Lens holder
134 Body tube
136, 148, 150, 160, 170 Image pickup module
137, 149, 152 Sensor
141 Thermosetting resin
144 First lens array
145 Second lens array

1. An image pickup lens comprising:
an aperture stop;
a first lens; and
a second lens,
the aperture stop, the first lens, and the second lens being sequentially arranged along a direction from an object to an image surface,
the first lens being a meniscus lens having a positive refracting power and having a convex surface facing the object,
the second lens being a lens having a negative refracting power, having a concave surface facing the object, and having a surface, facing the image surface, whose central portion has a concave shape,
the first lens having an Abbe number of greater than 45, the second lens having an Abbe number of greater than 45,
said image pickup lens satisfying mathematical expression (1):
−3.6<f2/f1<−2.5 (1)
where f1 is the focal length of the first lens and f2 is the focal length of the second lens.

2. The image pickup lens as set forth in claim 1, said image pickup lens having an F number of less than 3.

3. The image pickup lens as set forth in claim 1, said image pickup lens being obtained as a result of:
preparing a first lens array including a plurality of said first lens flush with one another and a second lens array including a plurality of said second lens flush with one another;
joining the first lens array and the second lens array so that at least two combinations of an optical axis of a first lens and an optical axis of a second lens corresponding to the first lens have their optical axes on different straight lines from each other; and then
dividing the first lens array and the second lens array thus joined into each single one of said combinations of an optical axis of a first lens and an optical axis of a second lens corresponding to the first lens.

4. The image pickup lens as set forth in claim 1, wherein at least either the first lens or the second lens is made of a resin that is cured by heat or ultraviolet rays.

5. An image pickup module comprising:
an image pickup lens comprising:
an aperture stop;
a first lens; and
a second lens,
the aperture stop, the first lens, and the second lens being sequentially arranged along a direction from an object to an image surface,
the first lens being a meniscus lens having a positive refracting power and having a convex surface facing the object,
the second lens being a lens having a negative refracting power, having a concave surface facing the object, and having a surface, facing the image surface, whose central portion has a concave shape,
the first lens having an Abbe number of greater than 45, the second lens having an Abbe number of greater than 45,
said image pickup lens satisfying mathematical expression (1):
−3.6<f2/f1<−2.5 (1)
where f1 is the focal length of the first lens and f2 is the focal length of the second lens; and
a solid-state image sensing device that receives as light an image formed by the image pickup lens.

6. The image pickup module as set forth in claim 5, wherein the solid-state image sensing device has a pixel size of 2.5 μm or less.

7. The image pickup module as set forth in claim 5, wherein the solid-state image sensing device has a pixel count of 1.3 million pixels or greater.

8. The image pickup module as set forth in claim 5, further comprising an image-surface protecting glass for protecting the image surface of the image pickup lens, wherein the image-surface protecting glass and the solid-state image sensing device are at a distance of 0.195 mm or greater from each other.

9. The image pickup module as set forth in claim 5, said image pickup module omitting to include a mechanism for adjusting a focus position of the image pickup lens.

10. The image pickup module as set forth in claim 5, said image pickup module omitting to include a body tube that houses the first lens and the second lens.

11. The image pickup module as set forth in claim 5, said image pickup module omitting to include a lens holder into which the first lens and the second lens are fitted.

12. A portable information device comprising an image pickup module comprising:
an image pickup lens comprising:
an aperture stop;
a first lens; and
a second lens,
the aperture stop, the first lens, and the second lens being sequentially arranged along a direction from an object to an image surface,
the first lens being a meniscus lens having a positive refracting power and having a convex surface facing the object,
the second lens being a lens having a negative refracting power, having a concave surface facing the object, and having a surface, facing the image surface, whose central portion has a concave shape,
the first lens having an Abbe number of greater than 45, the second lens having an Abbe number of greater than 45,
said image pickup lens satisfying mathematical expression (1):
−3.6<f2/f1<−2.5 (1)
where f1 is the focal length of the first lens and f2 is the focal length of the second lens; and
a solid-state image sensing device that receives as light an image formed by the image pickup lens.
